(19) United States
(12) Patent Application Publication
(10) Pub. No.: US 2009/0139833 A1
(43) Pub. Date: Jun. 4, 2009

(54) MULTI-LINE SUBSTRATE TREATING APPARATUS

(75) Inventors: Hiroyuki Ogura, Kyoto (JP); Tsuyoshi Mitsuhashi, Kyoto (JP); Yoshiteru Fukutomi, Kyoto (JP); Kenya Morinishi, Kyoto (JP); Yasuo Kawamatsu, Kyoto (JP); Hiromichi Nagashima, Kyoto (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: SOKUDO CO., LTD., Kyoto (JP)

(21) Appl. No.: 12/324,788

(22) Filed: Nov. 26, 2008

(30) Foreign Application Priority Data
Nov. 30, 2007 (JP) JP2007-310675

(51) Int. Cl. B65G 43/08

(52) U.S. Cl. 198/358

(57) ABSTRACT

A substrate treating apparatus includes substrate treatment lines arranged one over another, each for treating substrates while transporting the substrates substantially horizontally. The apparatus further includes an interface section for transporting the substrates between the substrate treatment lines and an exposing machine having a plurality of exposing stages, the exposing machine being provided separately from the apparatus, and a controller for controlling transport of the substrates in the interface section to cause all the substrates similarly treated in each of the substrate treatment lines to be exposed on one of the exposing stages. This apparatus can uniform the quality of treatment among a plurality of substrates receiving the same type of treatment in the same substrate treating line.

### CROSS-REFERENCES TO RELATED APPLICATIONS

This application claims priority to Japanese Patent Application No. JP2007-310675, filed on Nov. 30, 2007, the entire disclosure of which is hereby incorporated by reference in its entirety for all purposes.

### BACKGROUND OF THE INVENTION

This invention relates to a substrate treating apparatus for performing a series of treatments of substrates such as semiconductor wafers, glass substrates for liquid crystal displays, glass substrates for photomasks, and substrates for optical disks (hereinafter called simply “substrates”).

Conventionally, this type of apparatus is used to form a resist film on substrates and to develop the substrates exposed in a separate exposing machine. The apparatus includes a treating section having arranged therein at least a coating block for forming resist film, a developing block for developing the substrates. Each such treating block includes a single main transport mechanism and a plurality of chemical treating units and heat-treating units stacked vertically. The main transport mechanism of each block both transports substrates to the treating units in that block and transfers the substrates to and from the main transport mechanism of adjacent treating blocks to carry out a series of treatments of the substrates (as disclosed in Japanese Unexamined Patent Publication No. 2003-324139, for example).

The conventional apparatus with such a construction has the following drawbacks:

In the conventional apparatus various treating units are stacked vertically with the result that the quality of treatment tends to be different between the treating units which carry out the same treatment. This is considered due to variations in environment such as temperature and pressure between the treating units arranged vertically.

Further, where the exposing machine has a plurality of exposing stages, a difference may occur in the quality of exposure between these exposing stages. Even if the quality of treatment in forming resist film and development is uniform for the substrates assigning substrates to different exposing stages may cause the quality of entire treatment including exposure to be variable among the substrates.

### SUMMARY OF THE INVENTION

This invention has been made having regard to the state of the art noted above, and its objective is to provide a substrate treating apparatus that can produce a uniform quality of treatment among substrates.

According to this invention the above objective is fulfilled by a substrate treating apparatus comprising a plurality of substrate treatment lines arranged one over another with each line treating substrates while transporting the substrates substantially horizontally; an interface section for transporting the substrates between the substrate treatment lines, an exposing machine separate from the apparatus having a plurality of exposing stages, and a controller for controlling transport of the substrates in the interface section to cause all the substrates similarly treated in each of the substrate treatment lines to be exposed on one of the exposing stages.

According to this invention, each substrate treatment line treats the substrates while transporting the substrates substantially horizontally. Thus, even when a plurality of substrates receive the same type of treatment in the substrate treatment lines, relatively little variation occurs with the treating positions of the substrates. Therefore, each substrate treatment line can carry out uniform treatment for the plurality of substrates. Each exposing stage in the exposing machine can expose a plurality of substrates with the same quality. The controller causes all the plurality of substrates that receive the same type of treatment in the same substrate treatment line to be exposed on the same exposing stage. Compared with the case of using the plurality of exposing stages together, this control can inhibit variations in the quality of entire treatment including the treatment in the substrate treatment line and exposure in the exposing machine occurring among the plurality of substrates receiving the same type of treatment in the same substrate treatment line.

To carry out “the same type of treatment in the same substrate treatment line L” includes the case where all types of treatment are carried out in one substrate treatment line, and also the case where certain types of treatment are carried out in one substrate treatment line, and other types of treatment in another substrate treatment line.

In the invention noted above, the controller may be arranged to control the transport of the substrates in the interface section by referring to coordination information which determines for each substrate, at least one of which substrate treatment line to treat the substrate and which exposing stage to expose the substrate. By referring to the coordination information, the control by the controller is realized effectively.

The above coordination information may include substrate identification information which identifies each substrate actually transferred between the interface section and the exposing machine in the treatment information which determines at least one of which substrate treatment line to treat the substrate and which exposing stage to expose the substrate that is. Based on the substrate identification information included in the coordination information, the controller can identify each actual substrate conveniently. Based on the treatment information related to this substrate identification information, the controller can determine a substrate treatment line or exposing stage assigned to each actual substrate. When a substrate treatment line is determined, the controller can control transport of the substrate in the interface unit such that the substrate concerned receives treatment in the substrate treatment line determined. When an exposing stage is determined, the controller can control transport of the substrate in the interface unit such that the substrate concerned is exposed on the exposing stage determined. With the controller performing control in this way based on the coordination information, the substrates are transported such that all the substrates exposed on the same exposing stage are treated in the same substrate treatment line, that is, in a way that one substrate treatment line corresponds to one exposing stage.

In the invention noted above, treatment carried out in the substrate treatment lines may include resist film forming treatment for forming resist film on the substrates and post-exposure baking (PEB) treatment for heating the substrates after exposure; and the controller may be arranged to control the transport of the substrates in the interface section to cause all the substrates receiving the resist film forming treatment in each of the substrate treatment lines to be exposed on one of the exposing stages and to receive the post-exposure baking (PEB) treatment in one of the substrate treatment lines. The quality of the entire series of treatments including the resist film forming treatment, exposure and post-exposure baking (PEB) treatment can be made uniform among the plurality of substrates having received the resist film forming treatment in the same substrate treatment line.

The substrate treatment line which gives post-exposure baking (PEB) treatment to the substrates may be the substrate treatment line which has given the resist film forming treatment to the substrates. Then, the quality of the entire series of treatments can be made uniform with increased precision.

Each of the substrate treatment lines may include a plurality of main transport mechanisms arranged substantially horizontally; and a plurality of treating units provided for each of the main transport mechanisms for treating the substrates; each main transport mechanism being arranged to transfer the substrates to another main transport mechanism substantially horizontally adjacent thereto, while transporting the substrates to the treating units associated with the each main transport mechanism, thereby carrying out a series of treatments for the substrates. In this way, the substrate treatment lines may be constructed conveniently.

The treating units provided in each substrate treatment line may include resist film coating units for applying a resist film material to the substrates; and all the substrates with the resist film formed in each substrate treatment line may be exposed on one of the exposing stages. This can make uniform the quality of the series of treatments including the treatment for applying the resist film material to the substrates, and exposure of the substrates with the resist film formed.

The plurality of resist film coating units provided in each substrate treatment line may be arranged in substantially equal height positions. With the resist film coating units arranged in substantially equal height positions, the quality of treatment may be made uniform among these coating units.

The treating units provided in each substrate treatment line may further include PEB units for giving post-exposure baking (PEB) treatment to the substrates after exposure; and the substrate treatment line which gives post-exposure baking (PEB) treatment to the substrates may be the substrate treatment line which has applied the resist film material to the substrates. This can make uniform the quality of the series of treatments including the treatment for applying the resist film material, exposure and post-exposure baking (PEB) treatment. The quality may be made uniform with increased precision since the treatments before and after exposure are carried out in the same substrate treatment line.

In the invention noted above, the substrates may be transported to each of the substrate treatment lines and to the exposing machine at least twice, to form circuit patterns in at least two separate steps on a film acting as underlying film, the substrate treatment line to which the substrates are transported for a second time or later time being the same substrate treatment line to which the substrates are transported for a first time. The quality such as wiring pattern linewidth can be made uniform between the circuit pattern formed in the first step and one formed for the second or later step.

In another embodiment of the invention, a substrate treating apparatus comprises a treating section including a plurality of treating blocks arranged horizontally, each treating block having treating units arranged on each of vertical stories for treating substrates, and a main transport mechanism disposed on each story for transporting the substrates to and from the treating units on each story, a series of treatments being carried out by transferring the substrates between the main transport mechanisms on the same story of the treating blocks adjacent each other; an interface section disposed adjacent the treating section for transporting the substrates between the treating section and an exposing machine having a plurality of exposing stages, the exposing machine being provided separately from the apparatus; and a controller for controlling transport of the substrates in the interface section to cause all the substrates similarly treated on each of the stories to be exposed on one of the exposing stages.

According to this embodiment, since the treating section includes a plurality of treating blocks arranged side by side, the treating section can be formed or varied by selecting or substituting the type of each treating block as appropriate as suited to the contents and object of treatment carried out for the substrates. Further, the substrates are transferred between the main transport mechanisms on the same story of the treating blocks adjacent to each other to carry out a series of treatments for the substrates on that story. The term “the same story” means a story of the same level (height position). Thus, even where each story has a plurality of treating units of the same type arranged on each story, there is relatively little variation in the height position between these treating units. Therefore, uniform treatment can be carried out for the plurality of substrates on each story. The controller causes all the plurality of substrates that receive the same type of treatment on the same story to be exposed on the same exposing stage. This control can inhibit variations in the quality of entire treatment including the treatment in the substrate treatment line and exposure in the exposing machine occurring among the plurality of substrates receiving the same type of treatment on the same story.

All the plurality of substrates that receive the same type of treatment on the same story includes the case where all types of treatment are carried out on one story, and also the case where certain types of treatment are carried out on one story, and other types of treatment on another story.

In the embodiment noted above, the controller may be arranged to control the transport of the substrates in the interface section by referring to coordination information which determines for each substrate at least one of which story to treat the substrate and which exposing stage to expose the substrate. By referring to the coordination information, the control by the controller is realized effectively.

The coordination information may include substrate identification information which identifies each substrate actually transferred between the interface section and the exposing machine with treatment information which determines at least one of which story to treat the substrate and which exposing stage to expose the substrate. Based on the substrate identification information included in the coordination information, the controller can identify each actual substrate conveniently. Based on the treatment information related to this substrate identification information, the controller can determine a story or exposing stage assigned to each actual substrate. When a story is determined, the controller can control transport of the substrate in the interface unit such that the substrate concerned receives treatment on the story determined. When an exposing stage is determined, the controller can control transport of the substrate in the interface unit such that the substrate concerned is exposed on the exposing stage determined. Thus, the substrates are transported such that all the substrates exposed on the same exposing stage are treated on the same story, that is, in a way that one story corresponds to each exposing stage.

In the embodiments noted above, each story may have an atmosphere blocked off from that of the other. This allows the atmosphere of each story to be easily maintained clean. It is also easy to keep the environment on each story constant.

One of the treating blocks may be a coating block having resist film coating units arranged as the treating units on each story for applying a resist film material to the substrates; and all the substrates having the resist film formed thereon on each story may be exposed on one of the exposing stages. This can make uniform the series of treatments including the treatment for applying the resist film material to the substrates, and exposure of the substrates with the resist film formed.

The plurality of resist film coating units provided on each story may be arranged in substantially equal height positions. With the resist film coating units arranged in substantially equal height positions, the quality of treatment may be made uniform between these coating units.

One of the treating blocks different from the coating block may be a PEB block having PEB units arranged as the treating units on each story for carrying out post-exposure baking (PEB) treatment for heating the substrates after exposure; and the story having the PEB block which gives post-exposure baking (PEB) treatment to the substrates may be the story having the coating block which has applied the resist film material to the substrates. This can make uniform the quality of the series of treatments including the treatment for applying the resist film material, exposure and post-exposure baking (PEB) treatment. The quality may be made uniform with increased precision since the treatments before and after exposure are carried out on the same story.

The substrates may be transported to the treating section and to the exposing machine at least twice, to form circuit patterns in at least two separate steps on a film acting as underlying film, the story of the treating section to which the substrates are transported for a second time or later time being the same story of the treating section to which the substrates are transported for a first time. The quality such as wiring pattern linewidth can be made uniform between the circuit pattern formed in the first step and one formed for the second or later step.

In another embodiment of the invention, a substrate treating apparatus comprises a plurality of substrate treatment lines arranged one over another, each for treating substrates while transporting the substrates substantially horizontally; each substrate treatment line including film forming units for forming film on the substrates; wherein all the film forming units of each substrate treatment line which form the same type of film are arranged in substantially equal height positions.

According to this embodiment, each substrate treatment line treats the substrates while transporting the substrates substantially horizontally. Thus, the quality of treatment can be made uniform among the plurality of substrates transported to the same substrate treatment line. Further, where a plurality of film forming units are provided for forming the same type of film, these units are arranged in substantially equal height positions. Thus, there is no possibility of variations in the quality of treatment between these film forming units. Consequently, each substrate treatment line provides a uniform quality of treatment among the substrates.

The film forming units provided in each substrate treatment line may include a plurality of resist film coating units for forming resist film and all the resist film coating units of each substrate treatment line may be arranged in substantially equal height positions. This construction can make uniform the quality of substrate treatment among the resist film coating units of each substrate treatment line.

The film forming units provided in each substrate treatment line may include a plurality of antireflection film coating units for forming antireflection film on the substrates; and all the antireflection film coating units of each substrate treatment line may be arranged in substantially equal height positions. This construction can make uniform the quality of substrate treatment among the antireflection film coating units of each substrate treatment line.

The resist film coating units and the antireflection film coating units of each substrate treatment line may be stacked vertically. This construction realizes a reduced footprint.

The above apparatus may further comprise a main transport mechanism movable along a substantially horizontal transport path for transporting the substrates wherein the resist film coating units and the antireflection film coating units are arranged along the transport path of the main transport mechanism. Then, the main transport mechanism can transport the substrates efficiently to and from the resist film coating units and antireflection film coating units.

In a still further aspect of the invention, a substrate treating apparatus comprises an indexer section including an indexer transport mechanism for transporting substrates to and from a cassette configured to store a plurality of substrates; a coating block disposed adjacent the indexer section including coating units for applying a treating solution to the substrates and heat-treating units arranged on each of upper and lower stories, a main transport mechanism disposed on each story for transporting the substrates to and from the coating units and the heat-treating units on the each story; a developing block disposed adjacent the coating block including developing units for supplying a developer to the substrates and heat-treating units arranged on each of upper and lower stories, a main transport mechanism disposed on each story for transporting the substrates to and from the developing units and the heat-treating units on the each story; an interface section disposed adjacent the developing block including an interface transport mechanism for transporting the substrates to and from an exposing machine provided separately from the apparatus. All the coating units on each story which apply the same type of treating solution to the substrates are arranged in substantially equal height positions and the indexer transport mechanism transfers the substrates to and from the main transport mechanism on each story of the coating block. The main transport mechanism on each story of the coating block transfers the substrates to and from the main transport mechanism on the same story of the developing block; and the interface transport mechanism transfers the substrates to and from the main transport mechanism on each story of the developing block.

According to this embodiment, while the main transport mechanisms on the same story of the coating block and developing block transfer the substrates to each other, the substrates are treated in the varied types of treating units arranged on that story of the treating blocks. Thus, the quality of treatment can be made uniform among the substrates treated on the same story. Further, where a plurality of coating units are provided for applying the same type of treating solution to the substrates, these units are arranged in substantially equal height positions. Thus, there is no possibility of variations in the quality of treatment between these units. Consequently, each story can provide a uniform quality of the entire series of treatments including the coating treatment and associated heat treatment of the substrates, the exposure of the substrates and the development and associated heat treatment of the substrates.

The coating units provided on each story of the coating block may include a plurality of resist film coating units for applying a resist film material to the substrates, and a plurality of antireflection film coating units for applying an anti-reflection film forming solution to the substrates; and on each story, the resist film coating units may be arranged in substantially equal height positions, and the antireflection film coating units may be arranged in substantially equal height positions. This construction can make uniform the quality of substrate treatment among the plurality of resist film coating units on each story of the coating block. The construction can also make uniform the quality of substrate treatment among the plurality of antireflection film coating units on each story.

The heat-treating units of the developing block may include PEB units for carrying out post-exposure baking (PEB) treatment for the substrates after exposure. This construction can carry out on each story of the developing block post-exposure bake (PEB) treatment of the substrates after exposure and develop the substrates successively.

This specification discloses an invention directed to a multi-line substrate treating apparatus. Several exemplary embodiments are described below.

(1) In an embodiment of the substrate treating apparatus, the controller is arranged to carry out at least one of transmission and reception of the coordination information to/from the exposing machine to link one of the exposing stages to each substrate treatment line or story.

According to the apparatus defined in (1) above, with the controller constructed capable of communication with the exposing machine, a further embodiment of the apparatus can set the substrate treatment lines and exposing stages to an effective corresponding relationship regarding each substrate. Another embodiment of the apparatus can set the stories and exposing stages to an effective corresponding relationship regarding each substrate.

(2) In an embodiment of the substrate treating apparatus, the substrate identification information is transport information on times for or an order of actually transferring the substrates between the interface section and the exposing machine.

According to the apparatus defined in (2) above, the substrates can be identified conveniently by the timing of actually transferring the substrates.

(3) In a further embodiment of the substrate treating apparatus according to (2) above, the transport information is obtained from a time estimate based on at least a transport step for transporting the substrates and a treating step for treating the substrates.

According to the apparatus defined in (3) above, the transport information can be obtained easily.

(4) In a further embodiment of the substrate treating apparatus according to (3) above, the transport information is used in transferring the substrates from the interface section to the exposing machine, and the controller is arranged to carry out control for successively receiving the substrates delivered from a substrate treatment line or story selected based on the coordination information, and transferring the substrates to the exposing machine.

According to the apparatus defined in (4) above, the control by the controller is realized with increased ease.

(5) The substrate treating apparatus according to (3) above, wherein the transport information is used in returning the substrates from the exposing machine to the interface section, and the controller is arranged to carry out control for successively receiving the substrates from the exposing machine and transferring the substrates to a substrate treatment line or story selected based on the coordination information.

According to the apparatus defined in (5) above, the control by the controller is realized with increased ease.

(6) An embodiment of the substrate treating apparatus wherein the numbers of substrate treatment lines or stories and exposing stages are two each, and one exposing stage corresponds to one substrate treatment line or story, while the other exposing stage corresponds to the other substrate treatment line or story.

According to the apparatus defined in (6) above, the construction having two substrate treatment lines can coordinate effectively with the exposing machine having two exposing stages.

(7) An embodiment of the substrate treating apparatus wherein each of the different exposing stages correspond to a substrate treatment line or story.

According to the apparatus defined in (7) above, it is possible to avoid concentration of the substrates on one of the exposing stages, thereby eliminating the possibility of lowering the efficiency of the exposing machine.

(8) An embodiment of the substrate treating apparatus wherein treatment carried out in the substrate treatment lines includes pre-exposure treatment for treating the substrates before exposure and post-exposure treatment for treating the substrates after exposure; and the controller is arranged to control the transport of the substrates in the interface section to cause all the substrates receiving the pre-exposure treatment in a same one of the substrate treatment lines to be exposed on a same one of the exposing stages and to receive the post-exposure treatment in a same one of the substrate treatment lines.

According to the apparatus defined in (8) above, it is possible to make uniform the quality of the entire series of treatments including the exposure and the treatments before and after the exposure.

(9) An embodiment of the substrate treating apparatus according to (8) above wherein the substrate treatment line which gives the post-exposure treatment to the substrates is the substrate treatment line which has given the pre-exposure treatment to the substrates.

According to the apparatus defined in (9) above, it is possible to uniform the quality of the entire series of treatments with increased precision.

(10) The substrate treating apparatus according to (8) or (9) above, wherein the post-exposure treatment is a developing treatment for developing the substrates.

According to the apparatus defined in (10) above, the quality of developing treatment can be made uniform.

(11) An embodiment of the substrate treating apparatus wherein each substrate treatment line has an atmosphere blocked off from that of the other.

According to the apparatus defined in (11) above, the atmosphere of each substrate treatment line can be easily maintained clean. It is also easy to keep the environment of each substrate treatment line constant.

(12) An embodiment of the substrate treating apparatus wherein the substrate treatment lines have the main transport mechanisms and the treating units in substantially the same arrangement in plan view.

According to the apparatus defined in (12) above, the apparatus has a simplified construction.

(13) An embodiment of the substrate treating apparatus wherein the treating blocks have the main transport mechanisms and the treating units in substantially the same arrangement in plan view on the respective stories.

According to the apparatus defined in (13) above, the apparatus has a simplified construction.

(14) The substrate treating apparatus according to claim 9, wherein the main transport mechanisms are arranged to transport the substrates separately to and from the resist film coating units and the PEB units.

According to the apparatus defined in (14) above, a different one of the main transport mechanisms transports the substrates to and from the resist film coating units which treat the substrates before exposure or the PEB units which treat the substrates after exposure. This arrangement can transport the substrates efficiently in each substrate treatment line.

(15) An embodiment of the substrate treating apparatus wherein the treating units provided in each substrate treatment line include PEB units for giving post-exposure baking (PEB) treatment to the substrates after exposure; and all of the substrates exposed on one exposing stage receive the post-exposure baking (PEB) treatment in the same substrate treatment line.

According to the apparatus defined in (15) above, it is possible to make uniform the quality of the series of treatments including the exposure and the post-exposure baking (PEB) treatment.

(16) An embodiment of the substrate treating apparatus wherein the treating units provided in each substrate treatment line include developing units for developing the substrates; and all of the substrates exposed on one exposing stage are developed in the same substrate treatment line.

According to the apparatus defined in (15) above, the quality of developing treatment can be uniformed.

### BRIEF DESCRIPTION OF THE DRAWINGS

For the purpose of illustrating the invention, there are shown in the drawings several embodiments, it being understood, however, that the invention is not limited to the precise arrangement and instrumentalities shown.

FIG. 1 is a schematic view showing an outline of a substrate treating apparatus according to one embodiment;

FIG. 2 is a plan view showing an outline of the substrate treating apparatus according to one embodiment;

FIG. 3 is a schematic side view showing an arrangement of treating units included in the substrate treating apparatus;

FIG. 4 is a schematic side view showing an arrangement of treating units included in the substrate treating apparatus;

FIG. 5 is a view in vertical section taken on line a-a of FIG. 2;

FIG. 6 is a view in vertical section taken on line b-b of FIG. 2;

FIG. 7 is a view in vertical section taken on line c-c of FIG. 2;

FIG. 8 is a view in vertical section taken on line d-d of FIG. 2;

FIG. 9A is a plan view of coating units;

FIG. 9B is a sectional view of a coating unit;

FIG. 10 is a perspective view of a main transport mechanism;

FIG. 11 is a control block diagram of the substrate treating apparatus according to one embodiment;

FIG. 12 is a flow chart of a series of treatments of substrates;

FIG. 13 is a view schematically showing operations repeated by each transport mechanism;

FIG. 14 is a schematic view showing an example of coordination information;

FIG. 15 is a schematic view showing an example of coordination information;

FIG. 16 is a schematic view showing an example of coordination information; and

FIG. 17 is a schematic view showing an outline of a modified substrate treating apparatus.

### DETAILED DESCRIPTION OF THE INVENTION

One embodiment of this invention will be described in detail hereinafter with reference to the drawings.

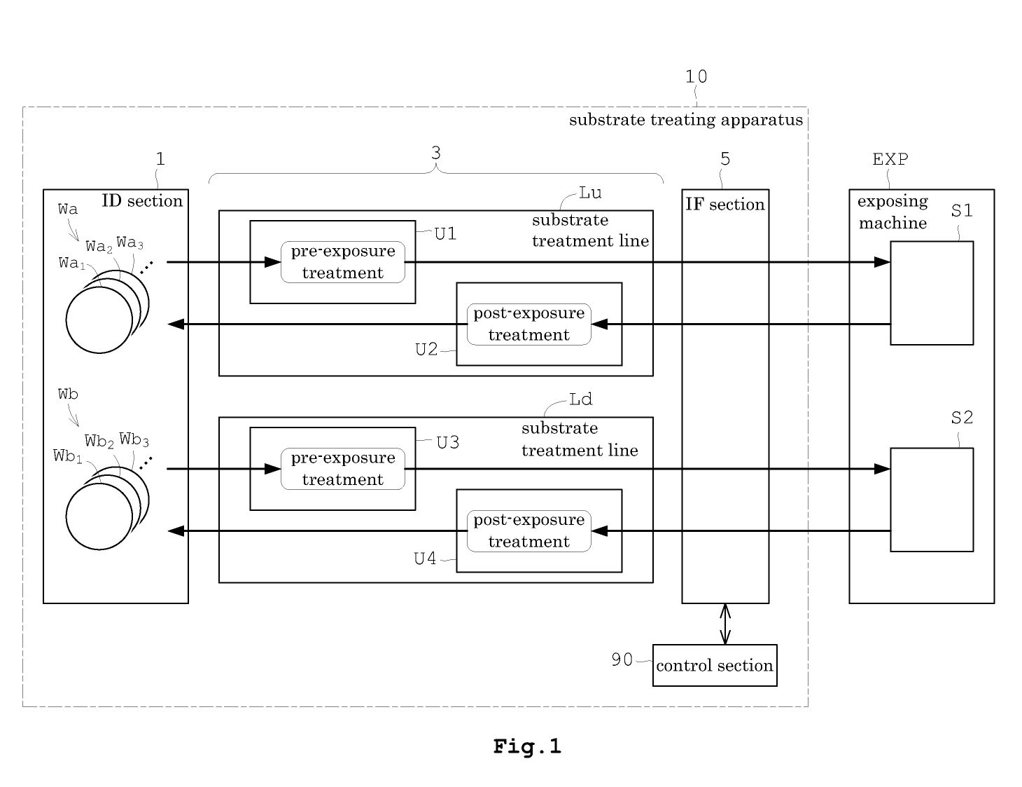

An outline of this embodiment will be described first. FIG. 1 is a schematic view showing an outline of a substrate treating apparatus according to this embodiment.

This embodiment provides a substrate treating apparatus 10 for forming resist film on substrates (e.g. semiconductor wafers) W, and developing exposed wafers W. The substrate treating apparatus 10 will be abbreviated hereinafter as the apparatus 10 as appropriate. This apparatus 10 includes an indexer section (hereinafter called “ID section”) 1, a treating section 3, an interface section (hereinafter called “IF section”) 5, and a control section 90. The ID section 1, treating section 3, and IF section 5 are arranged adjacent to one another in the stated order. An exposing machine EXP is disposed adjacent the IF section 5. The exposing machine EXP is an external apparatus separate from this apparatus 10.

The ID section 1 receives wafers W transported to the apparatus 10 from outside, and transfers the wafers W to the treating section 3. The treating section 3 includes a plurality of (e.g. two) substrate treatment lines Lu and Ld. Each substrate treatment line Lu and Ld treats the wafers W while transporting the wafers W substantially horizontally. The substrate treatment lines Lu and Ld are arranged one over the other. Each substrate treatment line Lu and Lu has one end thereof opposed to the ID section 1, and the other end opposed to the IF section 5. Each substrate treatment line Lu and Ld transfers the wafers W to and from the ID section 1 and IF section 5, respectively. In the following description, the substrate treatment lines Lu and Ld will be referred to simply as the substrate treatment lines L when they are not distinguished.

The substrate treatment line Lu includes treating units U1 and U2 for treating the wafers W. The substrate treatment line Ld includes treating units U3 and U4 for treating the wafers W. The treating units U1 and U3 carry out a predetermined treatment (pre-exposure treatment) of the wafers W before exposure. The pre-exposure treatment is resist film forming treatment for forming resist film on the wafers W, for example. The treating units U2 and U4 carry out a predetermined treatment (post-exposure treatment) of the wafers W after exposure. The post-exposure treatment includes, for example, post-exposure baking (PEB) treatment for heating the wafers W after exposure, and developing treatment for developing the wafers W. The treating units U1-U4 will be referred to simply as the treating units U when they are not distinguished.

The IF section 5 transfers the wafers W between the treating section 3 and exposing machine EXP. The control section 90 controls transport of the wafers W in the IF section 5. The exposing machine EXP has a plurality of (e.g. two) exposing stages S1 and S2 for exposing the wafers W.

The apparatus 10 constructed in this way operates as follows. The ID section 1 transports wafers Wa1, Wa2, Wa3, . . . to the substrate treatment line Lu, and transports wafers Wb1, Wb2, Wb3, . . . to the substrate treatment line Ld. The wafers Wa1, Wa2, Wa3, . . . transported to the substrate treatment line Lu receive the pre-exposure treatment in the treating units U1, respectively. The wafers Wb1, Wb2, Wb3, . . . transported to the substrate treatment line Ld receive the pre-exposure treatment in the treating units U3, respectively. In the following description, the plurality of wafers Wa1, Wa2, Wa3, . . . receiving the pre-exposure treatment in the substrate treatment line Lu will be called the group of wafers Wa, while the plurality of wafers Wb1, Wb2, Wb3, . . . receiving the pre-exposure treatment in the substrate treatment line Ld will be called the group of wafers Wb.

Then, the group of wafers Wa is transported from the substrate treatment line Lu to the IF section 5, and the group of wafers Wb from the substrate treatment line Ld to the IF section 5. The control section 90 controls transport of the wafers W in the IF section 5 to have the entire group of wafers Wa exposed on the exposing stage S1, and the entire group of wafers Wb exposed on the exposing stage S2. Based on this control, the IF section 5 transports the groups of wafers Wa and Wb to the exposing machine EXP. As a result, the group of wafers Wa is exposed on the exposing stage S1, and the group of wafers Wb on the exposing stage S2. The groups of wafers Wa and Wb exposed are transported from the exposing machine EXP to the IF section 5.

The control section 90 controls transport of the wafers W in the IF section 5, so that the post-exposure treatment may be carried out for the entire group of wafers Wa in the substrate treatment line Lu, and for the entire group of wafers Wb in the substrate treatment line Ld. Based on this control, the IF section 5 transports the group of wafers Wa to the substrate treatment line Lu, and the group of wafers Wb to the substrate treatment line Ld. The group of wafers Wa transported to the substrate treatment line Lu receives the post-exposure treatment in the treating units U2. Similarly, the group of wafers Wb transported to the substrate treatment line Ld receives the post-exposure treatment in the treating units U4. Subsequently, the group of wafers Wa is transported from the substrate treatment line Lu to the ID section 1, and the group of wafers Wb from the substrate treatment line Ld to the ID section 1.

As described above, the entire group of wafers Wa receives the pre-exposure treatment in the treating units U1, is exposed on the exposing stage S1, and receives the post-exposure treatment in the treating units U3. Thus, the entire group of wafers Wa has the same history of treatment. It is therefore possible to make uniform the quality of treatment for the group of wafers Wa. Similarly, the group of wafers Wb has a uniform quality of treatment. If part of the group of wafers Wa were exposed on the exposing stage S1 and the rest of the group of wafers Wa on the exposing stage S2, all the group of wafers Wa would not have the same history of treatment. The quality of treatment would tend to vary within the group of wafers Wa.

Where the plurality treating units U1 are provided for carrying out the same type of treatment, variations in height between the plurality of treating units U 1 are clearly smaller than variations in height between the treating units U1 and U2. Thus, surrounding environment such as temperature and pressure can be made substantially the same for the treating units U1 having a relatively small difference in vertical position. It is therefore possible to easily make uniform the quality of treatment for the treating units U1. The same can be said also for the other treating units U2-U4. That is, even where a plurality of treating units U2, U3 or U4 are provided, the quality of treatment can be made uniform easily for the same type of treating units U. Therefore, the quality of each type of treatment in the substrate treatment lines Lu and Ld can be made uniform for the wafers W.

The history of treatment of the wafers W in the apparatus 10 and exposing machine EXP can be divided into two types which correspond to the number of substrate treatment lines L (one is the history of treatment of the group of wafers Wa, and the other is the one of the group of wafers Wb). Thus, a follow-up check can be conducted easily of the history of treatment of each wafer W.

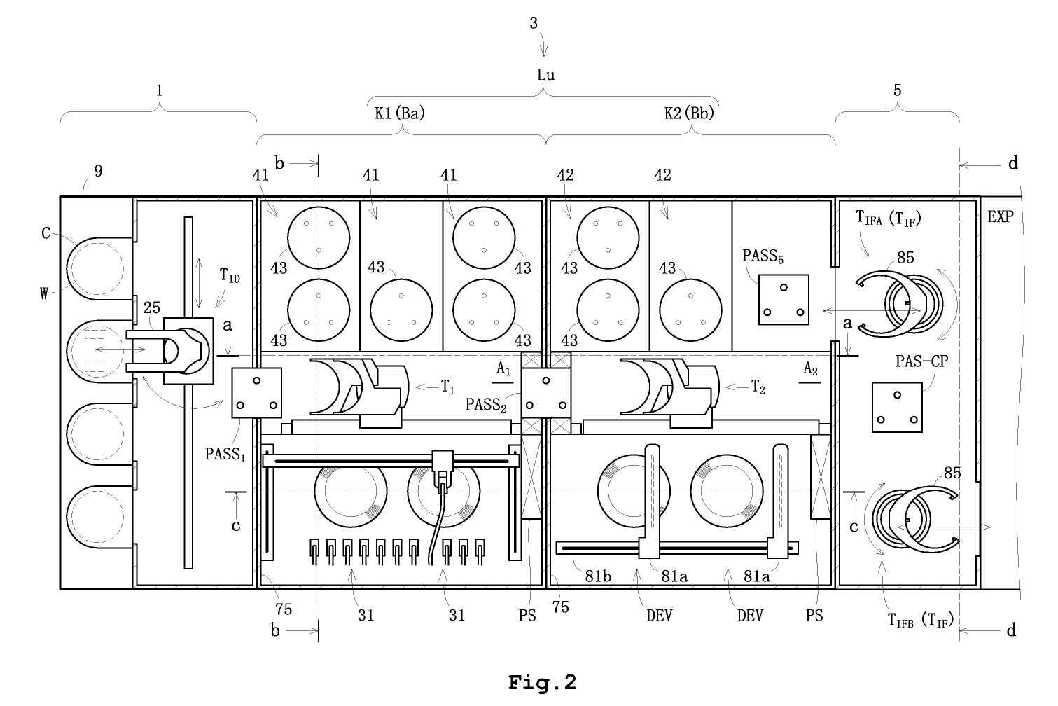

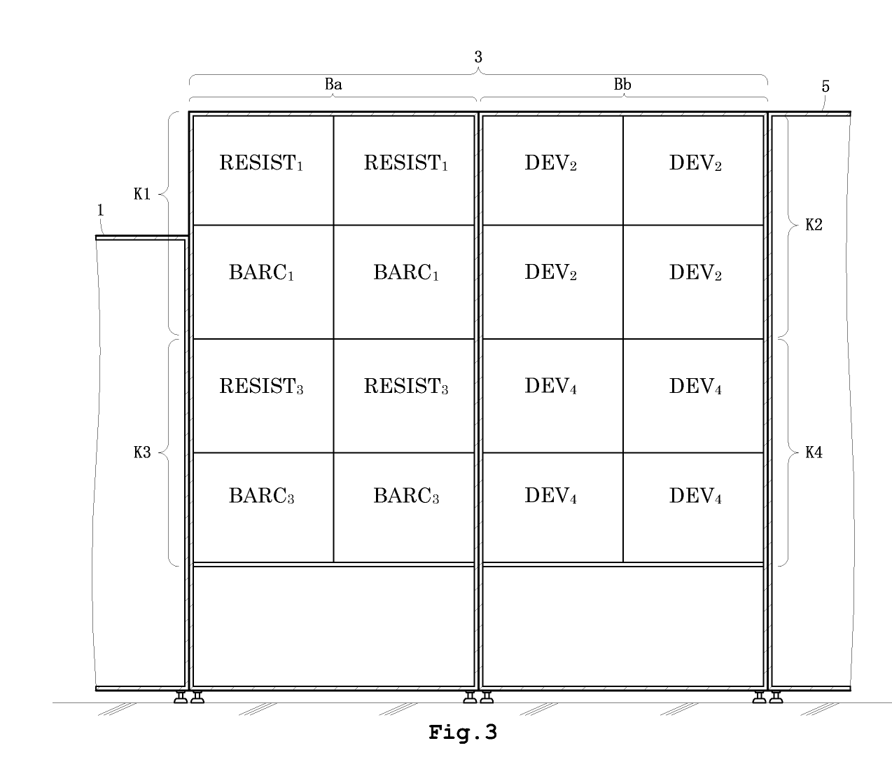

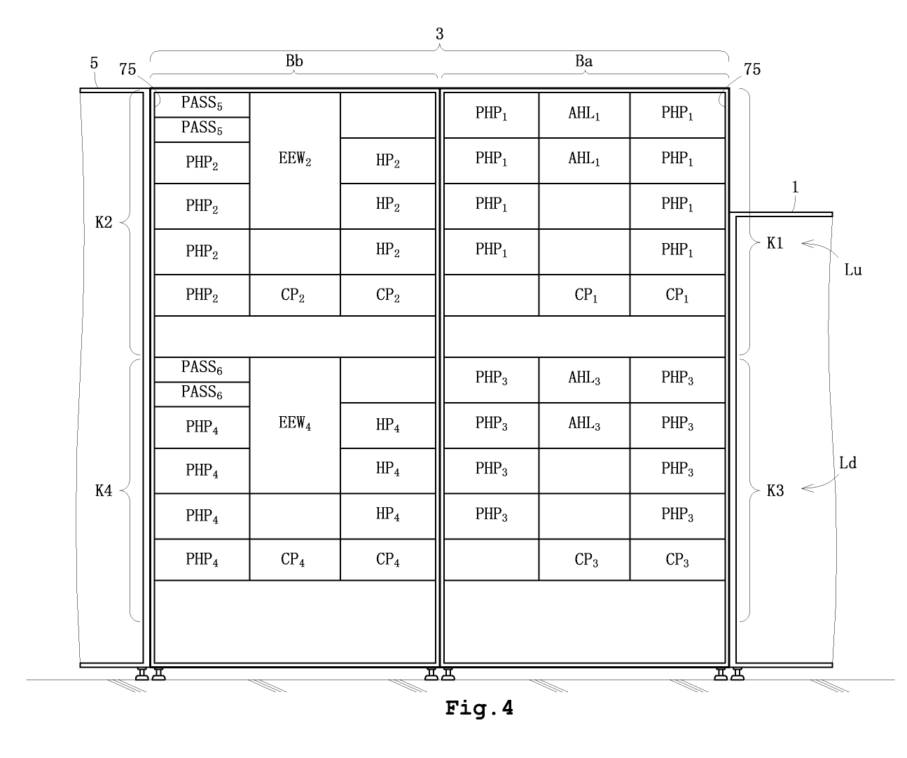

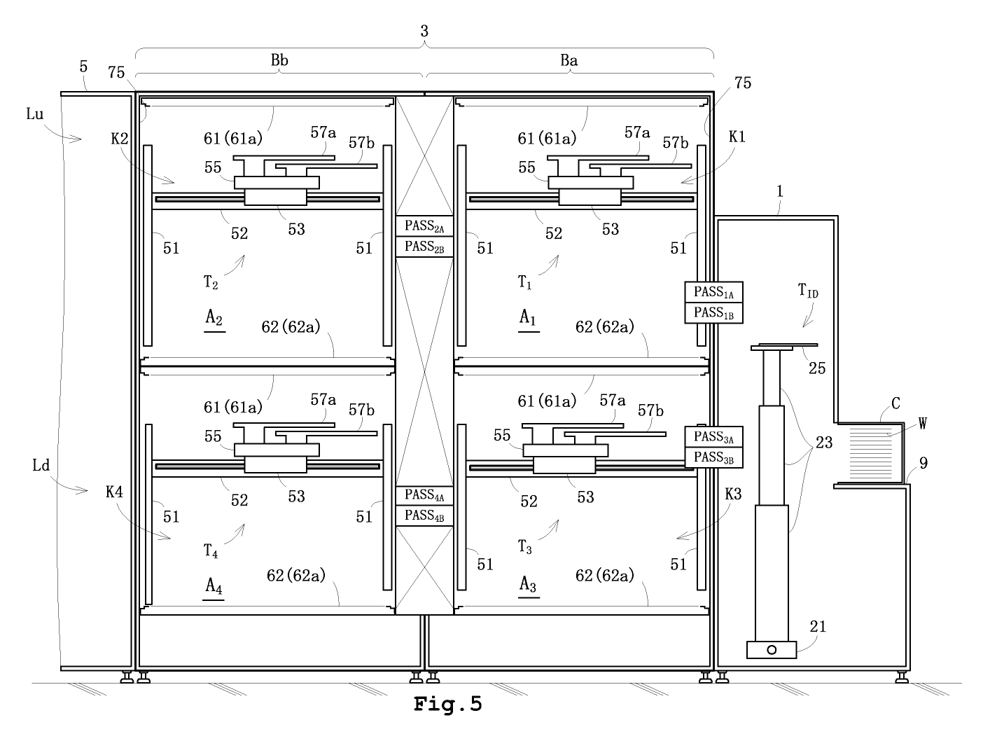

This embodiment will be described in greater detail hereinafter. FIG. 2 is a plan view showing an outline of the substrate treating apparatus according to this embodiment. FIGS. 3 and 4 are schematic side views showing an arrangement of treating units included in the substrate treating apparatus. FIGS. 5 through 8 are views in vertical section taken on lines a-a, b-b, c-c and d-d of FIG. 2, respectively.

### ID Section 1

The ID section 1 takes wafers W out of each cassette C, which stores a plurality of wafers W, and deposits wafers W in the cassette C. The ID section 1 has a cassette table 9 for receiving cassettes C. The cassette table 9 can receive four cassettes C as arranged in a row. The ID section 1 has also an ID transport mechanism T_{ID}. The ID transport mechanism T_{ID} transports wafers W to and from each cassette C, and transports wafers W to and from receivers PASS₁ and PASS₃ to be described hereinafter. As shown in FIG. 5, the ID transport mechanism T_{ID} has a movable base 21 for moving horizontally alongside the cassette table 9 in the direction of arrangement of the cassettes C, a lift shaft 23 vertically extendible and contractible relative to the movable base 21, and a holding arm 25 swivelable on the lift shaft 23, and extendible and retractable radially of the swivel motion, for holding a wafer W. The ID transport mechanism T_{ID} corresponds to the indexer transport mechanism in this invention.

### Substrate Treatment Lines L

Each substrate treatment line L has main transport mechanisms T for transporting wafers W substantially horizontally. In this embodiment, each substrate treatment line L has a plurality of main transport mechanisms T (two for each substrate treatment line L, and thus a total of four). The plurality of main transport mechanisms T of each substrate treatment line L are arranged in the direction in which the wafers W are transported, and the wafers W can be transferred between the main transport mechanisms T adjacent each other in the transport direction. The treating units U1-U4 are arranged around the main transport mechanisms T, and each main transport mechanism T can transport wafers W also to the associated treating units U. With each main transport mechanism T transporting wafers W to the associated treating units U and transferring wafers W to the other main transport mechanism T adjacent thereto, a series of treatments is carried out for the wafers W in each substrate treatment line L.

Specifically, the substrate treatment line Lu includes a main transport mechanism T₁ and a main transport mechanism T₂ arranged in a row. The main transport mechanism T₁ is disposed adjacent the ID section, while the main transport mechanism T₂ is disposed adjacent the IF section 5. Similarly, the substrate treatment line Ld includes a main transport mechanism T₃ and a main transport mechanism T₄ arranged in a row. The main transport mechanism T₃ is disposed adjacent the ID section, while the main transport mechanism T₄ is disposed adjacent the IF section 5.

### Treating Section 3

In this embodiment, the treating section 3 which has the above substrate treatment lines L includes a plurality of (two) treating blocks Ba and Bb arranged side by side (in substantially the same direction as the transport direction). The treating block Ba is vertically divided into a plurality of (two) stories K1 and K3. The treating block Bb also is vertically divided into a plurality of (two) stories K2 and K4. The stories K1 and K2 constitute the same story in the sense that their height levels are the same. Similarly, the stories K3 and K4 are the same story in the sense that their height levels are the same.

The above main transport mechanism T₁ and treating units U1 are arranged on the upper story K1 of the treating block Ba, while the main transport mechanism T₃ and treating units U3 are arranged on the lower story K3. Similarly, the main transport mechanism T₂ and treating units U are arranged on the upper story K2 of the treating block Bb, while the main transport mechanism T₄ and treating units U are arranged on the lower story K4. The treating units U on the story K2 include treating units U2 for the post-exposure treatment (e.g. developing units DEV) and a treating unit U1 for the pre-exposure treatment (e.g. edge exposing unit EEW). Similarly, the treating units U on the story K4 include treating units U4 for the post-exposure treatment and a treating unit U3 for the pre-exposure treatment.

The wafers W are transferred between the main transport mechanisms T on the same stories K of the adjoining treating blocks Ba and Bb, to carry out a series of treatments for the wafers W. The stories K1 and K2, connected for enabling the transfer of wafers W between the main transport mechanisms T₁ and T₂, constitute the substrate treatment line Lu. Similarly, the stories K3 and K4, connected for enabling the transfer of wafers W between the main transport mechanisms T₃ and T₄, constitute the substrate treatment line Ld.

### Treating Section 3—Treating Block Ba

The treating block Ba is disposed adjacent the ID section 1. Receivers PASS₁ and PASS₃ for receiving wafers W are provided between the ID section 1 and the respective stories K1 and K3 of the treating block Ba. The receiver PASS₁ receives, as temporarily placed thereon, wafers W passed between the ID transport mechanism T_{ID} and the main transport mechanism T₁. Similarly, the receiver PASS₃ receives, as temporarily placed thereon, wafers W passed between the ID transport mechanism T_{ID} and the main transport mechanism T₃. Seen in a sectional view, the receiver PASS₁ is disposed at a height adjacent to a lower part of the upper story K2, while the receiver PASS₃ is disposed at a height adjacent to an upper part of the lower story K3. Thus, the positions of receiver PASS₁ and receiver PASS₃ are relatively close to each other for allowing the ID transport mechanism T_{ID} to move between the receiver PASS₁ and receiver PASS₃ using only a small amount of vertical movement.

Receivers PASS₂ and PASS₄ for receiving wafers W are provided also between the treating blocks Ba and Bb. The receiver PASS₂ is disposed between the story K1 and story K2, and the receiver PASS₄ between the story K3 and story K4. The main transport mechanisms T₁ and T₂ transfer wafers W through the receiver PASS₂, and the main transport mechanisms T₃ and T₄ through the receiver PASS₄.

The receiver PASS₁ includes a plurality of receivers (two in this embodiment). These receivers PASS₁ are arranged vertically adjacent each other. Of the two receivers PASS₁, one PASS_{1A} receives wafers W passed from the ID transport mechanism T_{ID} to the main transport mechanism T₁. The other receiver PASS_{1B} receives wafers W passed from the main transport mechanism T₁ to the ID transport mechanism T_{ID}. Each of the receivers PASS₂-PASS₄ and receivers PASS₅ and PASS₆ described hereinafter similarly includes a plurality of (two) receivers, one of which is selected according to a direction for transferring wafers W. Each of the receivers PASS_{1A} and PASS_{1B} has a sensor (not shown) for detecting presence or absence of a wafer W. Based on detection signals of each sensor, the transfer of wafers W by the ID transport mechanism T_{ID} and main transport mechanism T₁ is controlled. Similar sensors are attached also to the receivers PASS₂-PASS₆, respectively.

The story K1 will now be described. The main transport mechanism T₁ is movable in a transporting space A₁ extending substantially through the center of the story K1 and parallel to the direction of transport. The treating units U1 on the story K1 are divided broadly into coating units 31 for applying a treating solution to wafers W, and heat-treating units 41 for heat-treating the wafers W. The coating units 31 are arranged on one side of the transporting space A₁, while the heat-treating units 41 are arranged on the other side thereof The treatments carried out in the coating units 31 and heat-treating units 41 are all pre-exposure treatments.

The coating units 31 are arranged vertically and horizontally, each facing the transporting space A₁. In this embodiment, four coating units 31 in total are arranged in two columns and two rows.

The coating units 31 include anti-reflection film coating units BARC for forming anti-reflection film on the wafers W, and resist film coating units RESIST for forming resist film on the wafers W (i.e. carrying out resist film forming treatment). The anti-reflection film coating units BARC and resist film coating units RESIST correspond to the film forming units in this invention.

The anti-reflection film coating units BARC apply a treating solution for antireflection film to the wafers W. The resist film coating units RESIST apply a resist film material to the wafers W. The plurality of (two) anti-reflection film coating units BARC are arranged at substantially the same height in the lower row. The plurality of resist film coating units RESIST are arranged at substantially the same height in the upper row. No dividing wall or partition is provided between the antireflection film coating units BARC. That is, all the antireflection film coating units BARC are only housed in a common chamber, and the atmosphere around each antireflection film coating unit BARC is not blocked off (i.e. is in communication). Similarly, the atmosphere around each resist film coating unit RESIST is not blocked off.

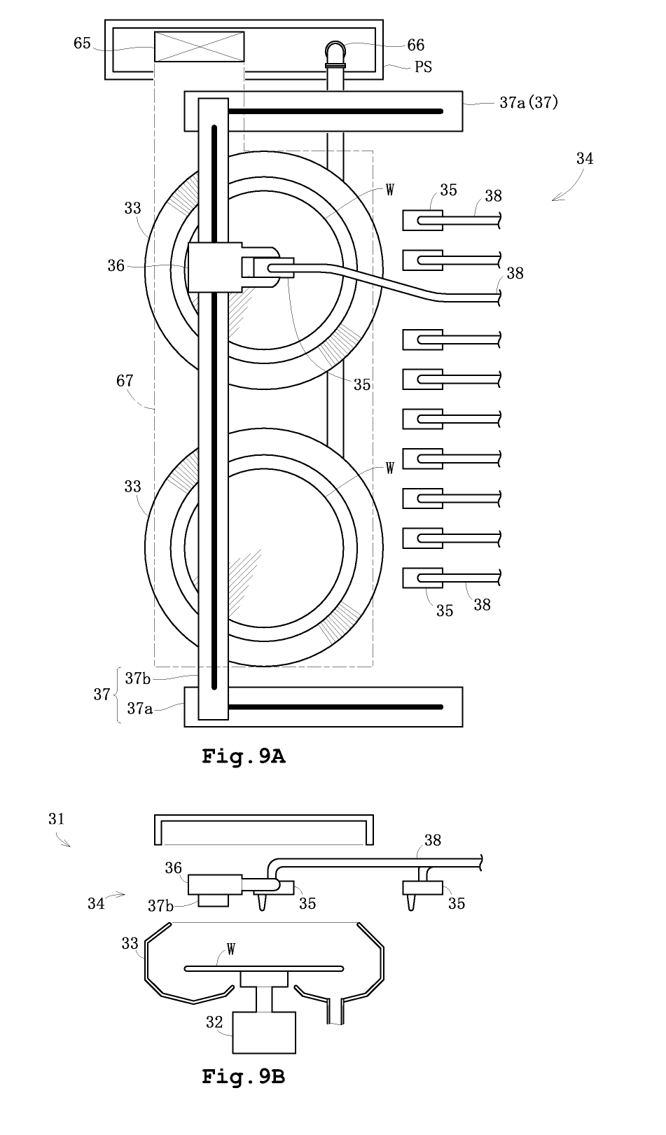

Reference is made to FIGS. 9A and 9B. FIG. 9A is a plan view of the coating units 31. FIG. 9B is a sectional view of a coating unit 31. Each coating unit 31 includes a spin holder 32 for holding and spinning a wafer W, a cup 33 surrounding the wafer W, and a supply device 34 for supplying a treating solution to the wafer W.

The supply device 34 includes a plurality of nozzles 35, a gripper 36 for gripping one of the nozzles 35, and a nozzle moving mechanism 37 for moving the gripper 36 to move one of the nozzles 35 between a treating position above the wafer W and a standby position away from above the wafer W. Each nozzle 35 has one end of a treating solution pipe 38 connected thereto. The treating solution pipe 38 is arranged movable (flexible) to permit movement of the nozzle 35 between the standby position and treating position. The other end of each treating solution pipe 38 is connected to a treating solution source (not shown). Specifically, in the case of antireflection film coating units BARC, the treating solution sources supply different types of treating solution for antireflection film to the respective nozzles 35. In the case of resist film coating units RESIST, the treating solution sources supply different types of resist film material to the respective nozzles 35.

Even though the treating solutions applied from the antireflection film coating units BARC to the wafers W are the same type or different types, the solutions are intended for antireflection film formation. Thus, each antireflection film coating unit BARC corresponds to a coating unit for applying a treating solution of the same type. Similarly, each resist film coating unit RESIST corresponds to a coating unit for applying a treating solution of the same type.

The nozzle moving mechanism 37 has first guide rails 37a and a second guide rail 37b. The first guide rails 37a are arranged parallel to each other and opposed to each other across the two cups 33 arranged sideways. The second guide rail 37b is slidably supported by the two first guide rails 37a and disposed above the two cups 33. The gripper 36 is slidably supported by the second guide rail 37b. The first guide rails 37a and second guide rail 37b take guiding action substantially horizontally and in directions substantially perpendicular to each other. The nozzle moving mechanism 37 further includes drive members (not shown) for sliding the second guide rail 37b, and sliding the gripper 36. The drive members are operable to move the nozzle 35 gripped by the gripper 36 to the treating positions above the two spin holders 32.

Referring back to FIG. 1 and FIG. 3, the plurality of heat-treating units 41 are arranged vertically and horizontally, each facing the transporting space A₁. In this embodiment, three heat-treating units 41 can be arranged horizontally, and five heat-treating units 41 can be stacked vertically. Each heat-treating unit 41 has a plate 43 for receiving a wafer W. The heat-treating units 41 include cooling units CP for cooling wafers W, heating and cooling units PHP for carrying out heating and cooling treatments continually, and adhesion units AHL for heat-treating wafers W in an atmosphere of hexamethyldisilazane (HMDS) vapor in order to promote adhesion of coating film to the wafers W. As shown in FIG. 5, each heating and cooling unit PHP has two plates 43, and a local transport mechanism (not shown) for moving a wafer W between the two plates 43. The various types of heat-treating units CP, PHP and AHL are arranged in appropriate positions.

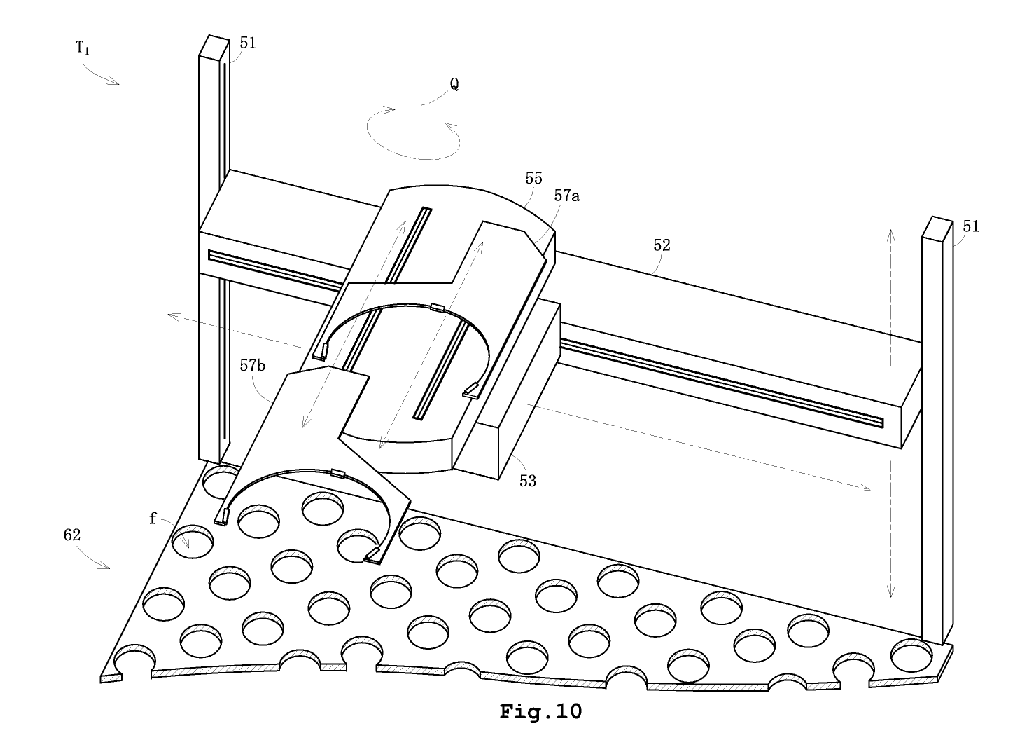

The main transport mechanism T₁ will be described specifically. Reference is made to FIG. 10. FIG. 10 is a perspective view of the main transport mechanism T₁. The main transport mechanism T₁ has two third guide rails 51 for providing vertical guidance, and a fourth guide rail 52 for providing horizontal guidance. The third guide rails 51 are fixed opposite each other at one side of the transporting space Al. In this embodiment, the third guide rails 51 are arranged at the side adjacent the coating units 31. The fourth guide rail 52 is slidably attached to the third guide rails 51. The fourth guide rail 52 has a base 53 slidably attached thereto. The base 53 extends transversely, substantially to the center of the transporting space Al. Further, drive members (not shown) are provided for vertically moving the fourth guide rail 52, and horizontally moving the base 53. The drive members are operable to move the base 53 to positions for accessing the coating units 31 and heat-treating units 41 arranged vertically and horizontally.

The base 53 has a turntable 55 rotatable about a vertical axis Q. The turntable 55 has two holding arms 57a and 57b horizontally movably attached thereto for holding wafers W, respectively. The two holding arms 57a and 57b are arranged vertically close to each other. Further, drive members (not shown) are provided for rotating the turntable 55, and moving the holding arms 57a and 57b. The drive members are operable to move the turntable 55 to positions opposed to the coating units 31, heat-treating units 41 and receivers PASS₁ and PASS₂, and to extend and retract the holding arms 57a and 57b to and from the coating units 31 and so on.

The story K3 will be described next. Like reference numerals are used to identify like parts which are the same as in the story K1, and will not be described again. The layout (arrangement) in plan view of the main transport mechanism T₃ and treating units in the story K3 is substantially the same as in the story K1. Thus, the arrangement of the various treating units of the story K3 as seen from the main transport mechanism T₃ is substantially the same as the arrangement of the various treating units of the story K1 as seen from the main transport mechanism T₁. The coating units 31 and heat-treating units 41 of the story K3 are stacked under the coating units 31 and heat-treating units 41 of the story K1, respectively. The treating block Ba constructed in this way corresponds to the coating block in this invention.

In the following description, when distinguishing the resist film coating units RESIST in the stories K1 and K3, subscripts “1” and “3” will be affixed (for example, the resist film coating units RESIST in the story K1 will be referred to as “resist film coating units RESIST₁”).

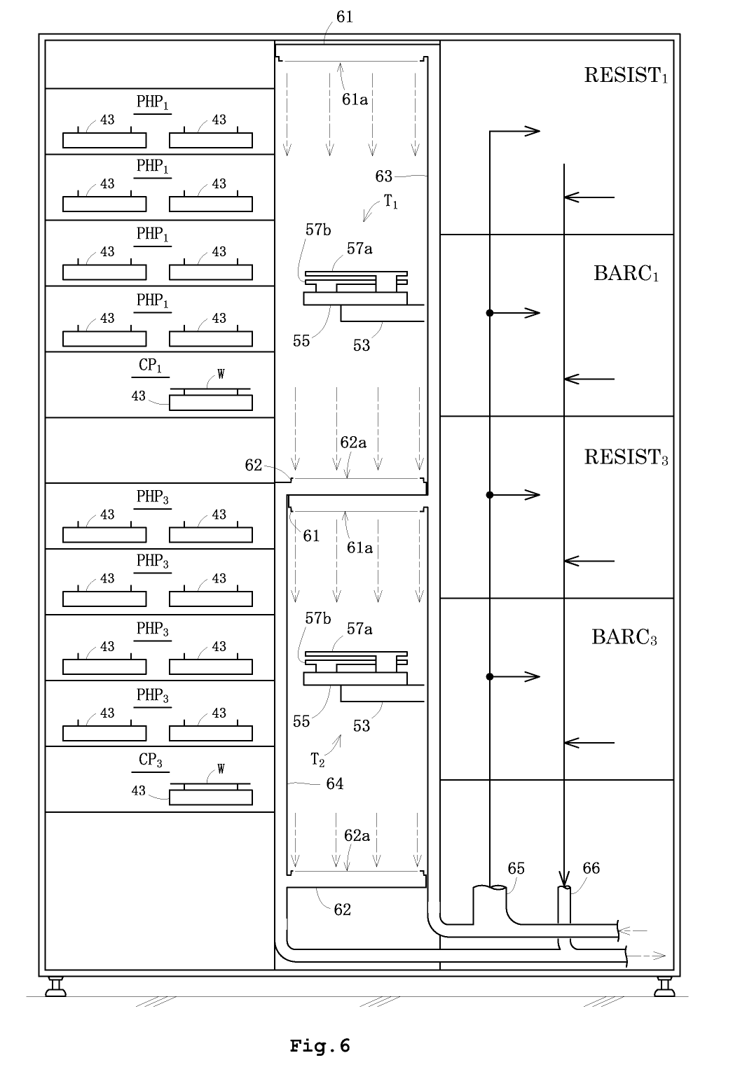

The other aspects of the treating block Ba will be described. As shown in FIGS. 5 and 6, each of the transporting spaces A₁ and A₃ has a first blowout unit 61 for blowing out a clean gas, and an exhaust unit 62 for sucking the gas. Each of the first blowout unit 61 and exhaust unit 62 is in the form of a flat box having substantially the same area as the transporting space A₁ in plan view. Each of the first blowout unit 61 and exhaust unit 62 has first blowout openings 61a or exhaust openings 62a formed in one surface thereof. In this embodiment, the first blowout openings 61a or exhaust openings 62a are in the form of numerous small bores f (see FIG. 10). The first blowout units 61 are arranged over the transporting spaces A₁ and A₃ with the first blowout openings 61a directed downward. The exhaust units 62 are arranged under the transporting spaces A₁ and A₃ with the exhaust openings 62a directed upward. The atmosphere in the transporting space A₁ and the atmosphere in the transporting space A₃ are blocked off by the exhaust unit 62 of the transporting space A₁ and the first blowout unit 61 of the transporting space A₃. Thus, each of the stories K1 and K3 has the atmosphere blocked off from the other.

Referring to FIG. 6, the first blowout units 61 of the transporting spaces A₁ and A₃ are connected to a common, first gas supply pipe 63. The first gas supply pipe 63 extends laterally of the receivers PASS₂ and PASS₄ from an upper position of the transporting space A₁ to a lower position of the transporting space A₃, and is bent below the transporting space A₃ to extend horizontally. The other end of the first gas supply pipe 63 is connected to a gas source not shown. Similarly, the exhaust units 62 of the transporting spaces A₁ and A₃ are connected to a common, first gas exhaust pipe 64. The first gas exhaust pipe 64 extends laterally of the receivers PASS₂ and PASS₄ from a lower position of the transporting space A₁ to a lower position of the transporting space A₃, and is bent below the transporting space A₂ to extend horizontally. As the gas is blown out of each first blowout opening 61 a and sucked and exhausted through each exhaust opening 62a of the transporting spaces A₁ and A₃, gas currents are formed to flow from top to bottom of the transporting spaces A₁ and A₃, thereby keeping each of the transporting spaces A₁ and A₃ in a clean state.

As shown in FIGS. 2, 7 and 9A, each coating unit 31 of the stories K1 and K3 has a pit portion PS extending vertically. The pit portion PS accommodates a second gas supply pipe 65 extending vertically for supplying the clean gas, and a second gas exhaust pipe 66 extending vertically for exhausting the gas. Each of the second gas supply pipe 65 and second gas exhaust pipe 66 branches at a predetermined height in each coating unit 31 to extend substantially horizontally from the pit portion PS. A plurality of branches of the second gas supply pipe 65 are connected to second blowout units 67 for blowing out the gas downward. A plurality of branches of the second gas exhaust pipe 66 are connected for communication to the bottoms of the respective cups 33. The other end of the second gas supply pipe 65 is connected to the first gas supply pipe 63 below the story K3. The other end of the second gas exhaust pipe 66 is connected to the first gas exhaust pipe 64 below the story K3. As the gas is blown out of the second blowout units 67 and exhausted through the second exhaust pipes 62a, the atmosphere inside each cup 33 is constantly maintained clean, thereby allowing for excellent treatment of the wafer W held by the spin holder 32.

The pit portions PS further accommodate piping of the treating solutions, electric wiring and the like (not shown). Thus, with the pit portions PS accommodating the piping and electric wiring provided for the coating units 31 of the stories K1 and K3, the piping and electric wiring can be reduced in length.

The treating block Ba has one housing 75 for accommodating the main transport mechanisms T₁ and T₃ and treating units U1 and U3 described hereinbefore. The treating block Bb described hereinafter also has a housing 75 for accommodating the main transport mechanisms T₂ and T₄ and the treating units U2 and U4 associated therewith. The housing 75 of the treating block Ba and the housing 75 of the treating block Bb are separate entities. Thus, with each of the treating blocks Ba and Bb having the housing 75 accommodating the main transport mechanisms T and treating units U en bloc, the treating section 3 may be manufactured and assembled simply.

### Treating Section 3—Treating Block Bb

The treating block Bb is disposed adjacent the IF section 5. The story K2 will be described. Like reference numerals are used to identify like parts which are the same as in the story K1 and will not be described again.

The story K2 has a transporting space A₂ formed as an extension of the transporting space A₁. The treating units U on the story K2 are developing units DEV for developing wafers W, heat-treating units 42 for heat-treating the wafers W, and an edge exposing unit EEW for exposing peripheral regions of the wafers W. The developing units DEV are arranged at one side of the transporting space A₂, and the heat-treating units 42 and edge exposing unit EEW are arranged at the other side of the transporting space A₂. Preferably, the developing units DEV are arranged at the same side as the coating units 31. It is also preferable that the heat-treating units 42 and edge exposing unit EEW are arranged in the same row as the heat-treating units 41. The developing units DEV and heat-treating units 42 are the treating units U2 for the post-exposure treatment. The edge exposing unit EEW is the treating unit U1 for the pre-exposure treatment.

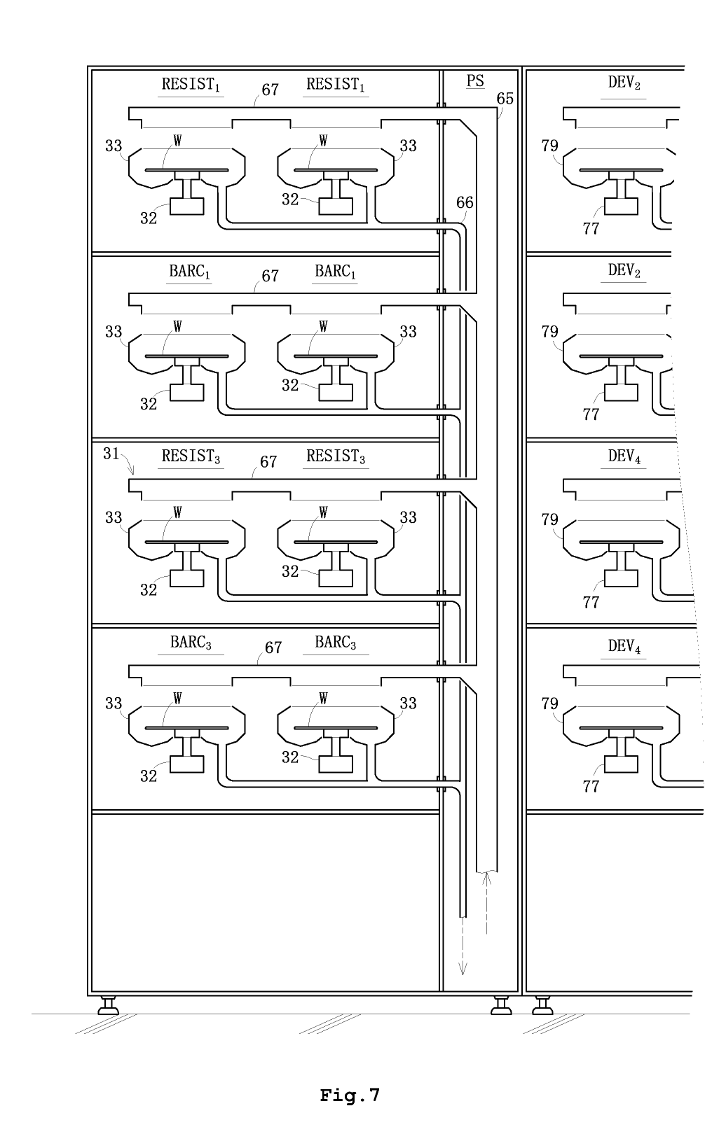

The number of developing units DEV is four, and sets of two units DEV arranged horizontally along the transporting space A₂ are stacked one over the other. As shown in FIGS. 2 and 7, each developing unit DEV includes a spin holder 77 for holding and spinning a wafer W, and a cup 79 surrounding the wafer W. The two developing units DEV arranged at the lower level are not separated from each other by a partition wall or the like. A supply device 81 is provided for supplying developers to the two developing units DEV. The supply device 81 includes two slit nozzles 81a having a slit or a row of small bores for delivering the developers. The slit or row of small bores, preferably, has a length corresponding to the diameter of wafer W. Preferably, the two slit nozzles 81a are arranged to deliver developers of different types or concentrations. The supply device 81 further includes a moving mechanism 81b for moving each slit nozzle 81a. Thus, the slit nozzles 81a are movable, respectively, over the two spin holders 77 juxtaposed sideways.

The plurality of heat-treating units 42 are arranged sideways along the transporting space A₂, and stacked one over the other. The heat-treating units 42 include heating units HP for heating wafers W, cooling units CP for cooling wafers W, and heating and cooling units PHP for successively carrying out heating treatment and cooling treatment.

The plurality of heating and cooling units PHP are vertically stacked in the column closest to the IF section 5, each having one side facing the IF section 5. The heating and cooling units PHP on the story K2 have transport ports formed in the sides thereof for passage of wafers W. IF transport mechanisms T_{IF} to be described hereinafter transport wafers W through the above transport ports to the heating and cooling units PHP. The heating and cooling units PHP arranged on the story K2 carry out post-exposure baking (PEB) treatment. Thus, the heating and cooling units PHP on the story K2 correspond to the PEB units in this invention.

The single edge exposing unit EEW is disposed in a predetermined position. The edge exposing unit EEW includes a spin holder (not shown) for holding and spinning a wafer W, and a light emitter (not shown) for exposing edges of the wafer W held by the spin holder.

The receiver PASS₅ is formed on top of the heating and cooling units PHP on the story K2. The main transport mechanism T₂ and IF transport mechanisms T_{IF} to be described hereinafter transfer wafers W through the receiver PASS₅.

The main transport mechanism T₂ is disposed substantially centrally of the transporting space A₂ in plan view. The main transport mechanism T₂ has the same construction as the main transport mechanism T₁. The main transport mechanism T₂ transports wafers W to and from the receiver PASS₂, various heat-treating units 42, edge exposing unit EEW and receiver PASS₅.

The story K4 will be described briefly. The relationship in construction between story K2 and story K4 is similar to that between stories K1 and K3. The treating units U on the story K4 are developing units DEV, heat-treating units 42 and an edge exposing unit EEW. The heat-treating units 42 on the story K4 include heating units HP, cooling units CP and heating and cooling units PHP. The receiver PASS₆ is formed on top of the heating and cooling units PHP on the story K4. The main transport mechanism T₄ and IF transport mechanisms T_{IF} described hereinafter transfer wafers W through the receiver PASS₆. The heating and cooling units PHP on the story K4 also correspond to the PEB units in this invention.

In the following description, when distinguishing the developing units DEV, edge exposing units EEW and so on provided on the stories K2 and K4, subscripts “2” and “4” will be affixed (for example, the heating units HP on the story K2 will be referred to as “heating units HP₂”).

Each of the transporting spaces A₂ and A₄ of the stories K2 and K4 also has constructions corresponding to the first blowout unit 61 and exhaust unit 62. Each developing unit DEV of the stories K2 and K4 also has constructions corresponding to the second blowout unit 67 and second gas exhaust pipe 66.

The treating block Bb constructed in this way corresponds to the PEB block in this invention. The treating block Bb corresponds also to the developing block in this invention.

### IF Section 5, etc.

The IF section 5 transfers wafers W between each of the substrate treatment lines Lu and Ld (stories K2 and K4) of the treating section 3 and the exposing machine EXP. The IF section 5 has IF transport mechanisms T_{IF} for transporting wafers W. The IF transport mechanisms T_{IF} include a first transport mechanism T_{IFA} and a second transport mechanism T_{IFB} that can transfer wafers W to and from each other. The first transport mechanism T_{IFA} transports wafers W to and from the substrate treatment lines Lu and Ld. In this embodiment, as described hereinbefore, the first transport mechanism T_{IFA} transports wafers W to and from the receivers PASS₅ and PASS₆ on the stories K2 and K4, and to and from the heating and cooling units PHP on the stories K3 and K4. The second transport mechanism T_{IFB} transports wafers W to and from the exposing machine EXP. The IF transport mechanisms T_{IF} correspond to the interface transport mechanisms in this invention.

As shown in FIG. 2, the first transport mechanism T_{IFA} and second transport mechanism T_{IFB} are arranged in a transverse direction perpendicular to the transport direction of the substrate treatment lines L. The first transport mechanism T_{IFA} is disposed at the side where the heat-treating units 42 and so on of the stories K2 and K4 are located. The second transport mechanism T_{IFB} is disposed at the side where the developing units DEV of the stories K2 and K4 are located. Stacked in multiples stages between the first and second transport mechanisms T_{IFA} and T_{IFB} are a receiver PASS-CP for receiving and cooling wafers W, a receiver PASS₇ for receiving wafers W, and buffers BF for temporarily storing wafers W. The first and second transport mechanisms T_{IFA} and T_{IFB} transfer wafers W through the receiver PASS-CP and receiver PASS₇. The buffers BF are accessed exclusively by the first transport mechanism T_{IFA}.

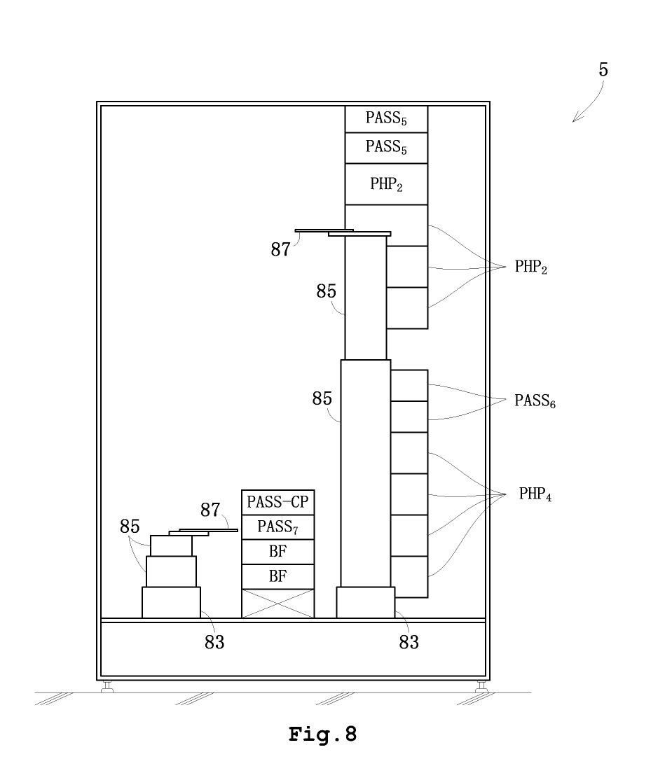

As shown in FIG. 8, the first transport mechanism T_{IFA} includes a fixed base 83, lift shafts 85 vertically extendible and contractible relative to the base 83, and a holding arm 87 swivelable on the lift shafts 85, and extendible and retractable radially of the swivel motion, for holding a wafer W. The second transport mechanism T_{IFB} also has a base 83, lift shafts 85 and a holding arm 87.

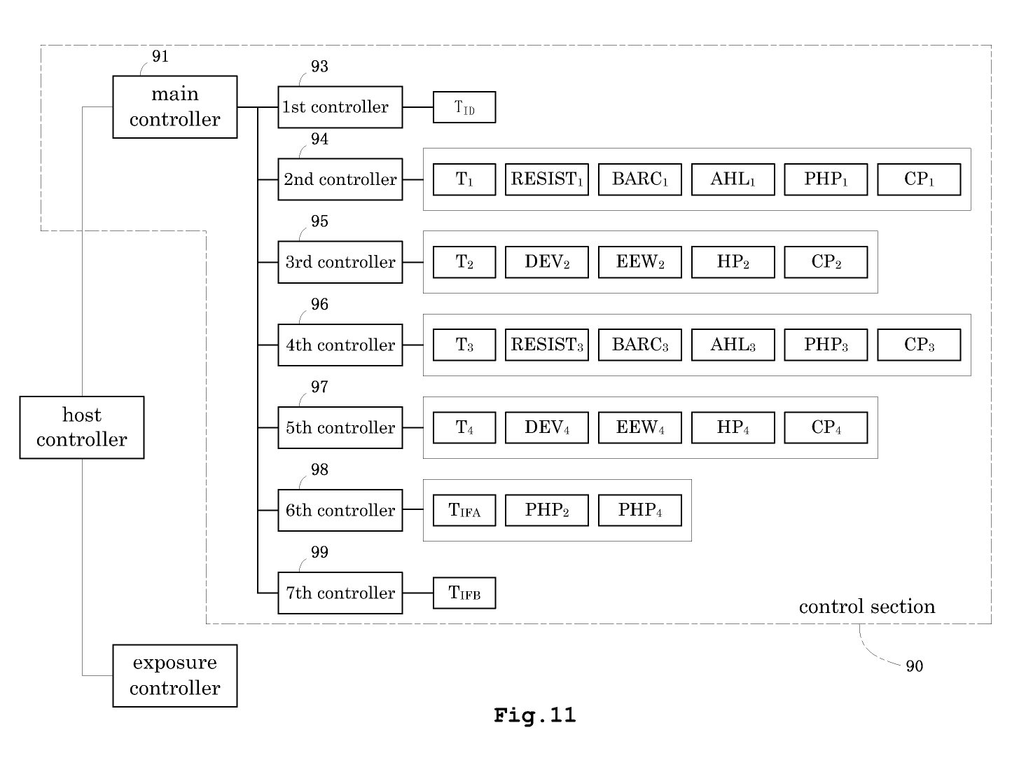

A control system of this apparatus 10 will be described next. FIG. 11 is a control block diagram of the substrate treating apparatus according to the invention. As shown, the control section 90 of this apparatus 10 includes a main controller 91 and a first to a seventh controllers 93, 94, 95, 96, 97, 98 and 99.

The main controller 91 performs overall control of the first to seventh controllers 93-99. Further, the main controller 91 can communicate through a host computer with an exposing machine controller provided for the exposing machine EXP. The first controller 93 controls substrate transport by the ID transport mechanism T_{ID}. The second controller 94 controls substrate transport by the main transport mechanism T₁, and substrate treatment in the resist film coating units RESIST₁, antireflection film coating units BARC₁, cooling units CP₁, heating and cooling units PHP₁ and adhesion units AHL₁. The third controller 95 controls substrate transport by the main transport mechanism T₂, and substrate treatment in the edge exposing unit EEW₂, developing units DEV₂, heating units HP₂ and cooling units CP₂. The controls by the fourth and fifth controllers 96 and 97 correspond to those by the second and third controllers 94 and 95, respectively. The sixth controller 98 controls substrate transport by the first transport mechanism T_{IFA}, and substrate treatment in the heating and cooling units PHP₂ and PHP₄. The seventh controller 99 controls substrate transport by the second transport mechanism T_{IFB}. The first to seventh controllers 93-99 carry out the controls independently of one another.

Each of the main controller 91 and the first to seventh controllers 93-99 is realized by a central processing unit (CPU) which performs various processes, a RAM (Random Access Memory) used as the workspace for operation processes, and a storage medium such as a fixed disk for storing a variety of information including a predetermined processing recipe (processing program).

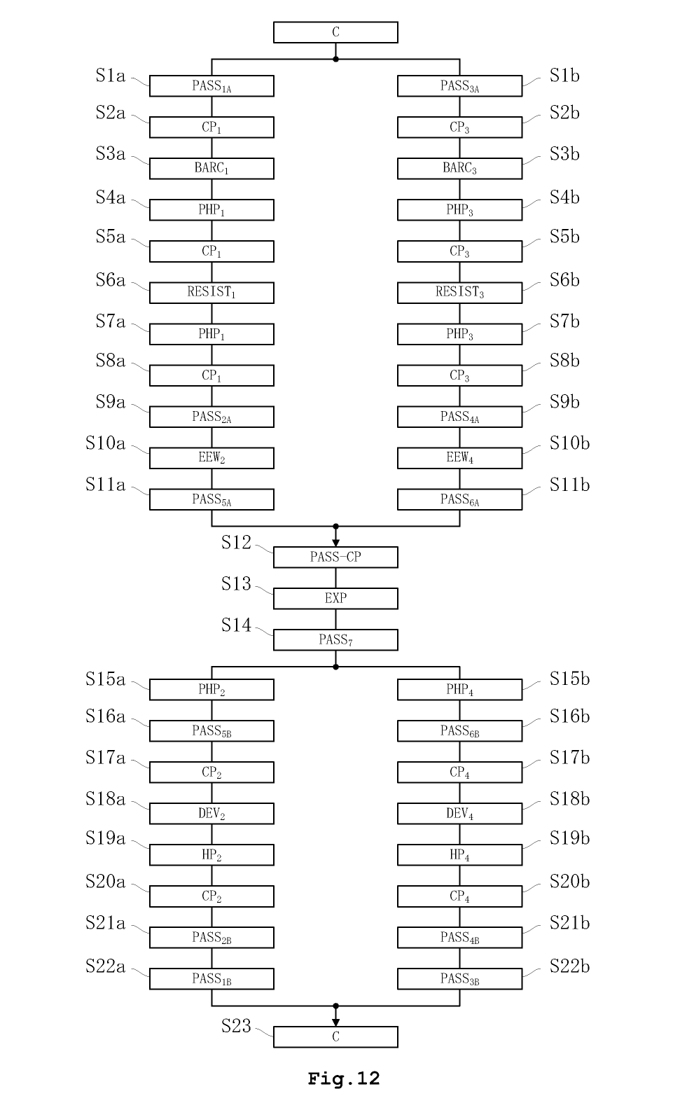

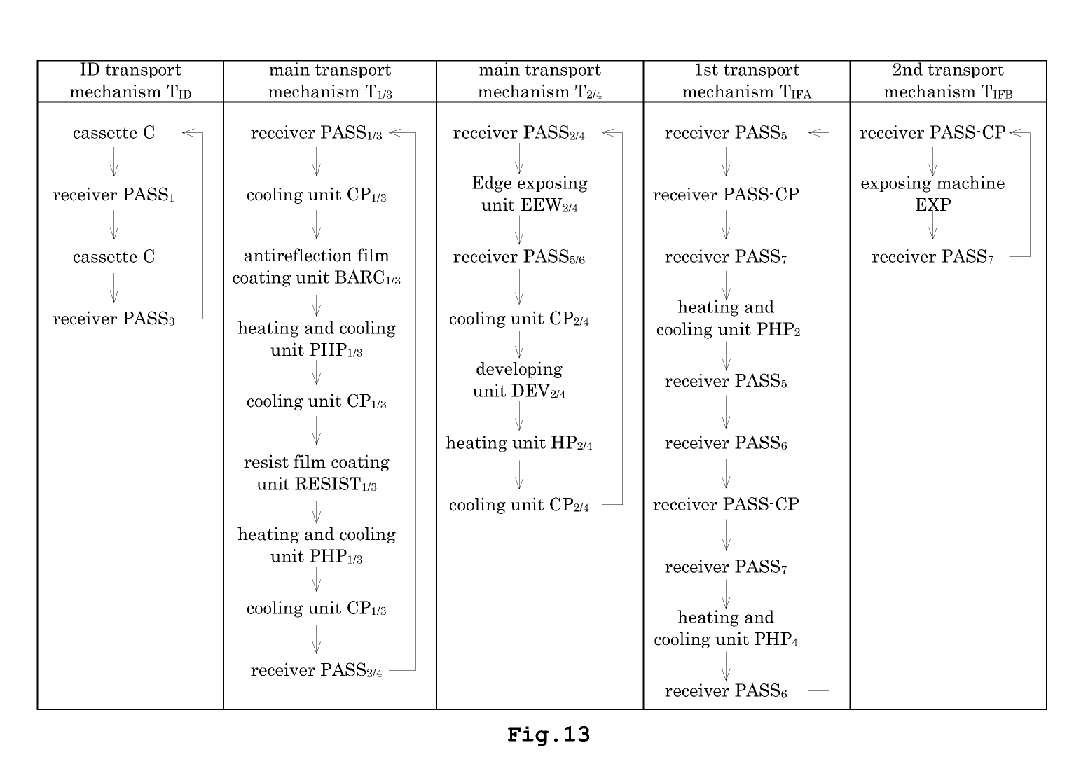

Next, operation of the substrate treating apparatus in this embodiment will be described. FIG. 12 is a flow chart of a series of treatments of wafers W, indicating the treating units and receivers to which the wafers W are transported in order. FIG. 13 is a view schematically showing operations repeated by each transport mechanism, and specifying an order of treating units, receivers and cassettes accessed by the transport mechanisms. The following description will be made separately for each transport mechanism.

### ID Transport Mechanism T_{ID}

The ID transport mechanism T_{ID} moves to a position opposed to one of the cassettes C, holds with the holding arm 25 a wafer W to be treated and takes the wafer W out of the cassette C. The ID transport mechanism T_{ID} swivels the holding arm 25, vertically moves the lift shaft 23, moves to a position opposed to the receiver PASS₁, and places the wafer W on the receiver PASS_{1A} (which corresponds to step S1a in FIG. 12; only step numbers will be indicated hereinafter). At this time, a wafer W usually is present on the receiver PASS_{1B}, and the ID transport mechanism T_{ID} receives this wafer W and stores it in a cassette C (step S23). When there is no wafer W on the receiver PASS_{1B}, step S23 is omitted. Then, the ID transport mechanism T_{ID} accesses the cassette C, and transports a wafer W from the cassette C to the receiver PASS_{3A} (step S1b). Here again, if a wafer W is present on the receiver PASS_{3B}, the ID transport mechanism T_{ID} will store this wafer W in a cassette C (step S23). The ID transport mechanism T_{ID} repeats the above operation.

This operation of the ID transport mechanism T_{ID} is controlled by the first controller 93. As a result, the wafers W in the cassette C are fed to the story K1, and the wafers W delivered from the story K1 are stored in the cassette C. Similarly, the wafers W in the cassette C are fed to the story K3, and the wafers W delivered from the story K3 are stored in the cassette C.

### Main Transport Mechanisms T₁, T₃

Since operation of the main transport mechanism T₃ is substantially the same as operation of the main transport mechanism T₁, only the main transport mechanism T₁ will be described. The main transport mechanism T₁ moves to a position opposed to the receiver PASS₁. At this time, the main transport mechanism T₁ holds on one holding arm 57 (e.g. 57b) a wafer W received immediately before from the receiver PASS_{2B}. The main transport mechanism T₁ places this wafer W on the receiver PASS_{1B} (step S22), and holds the wafer W present on the receiver PASS_{1A} with the other holding arm 57 (e.g. 57a).

The main transport mechanism T₁ accesses a predetermined one of the cooling units CP₁. There is a different wafer W having already received a predetermined heat treatment (cooling) in the cooling unit CP₁. The main transport mechanism T₁ holds the different wafer W with the unloaded holding arm 57 (holding no wafer W), takes it out of the cooling unit CP₁, and loads into the cooling unit CP₁ the wafer W having received from the receiver PASS_{1A}. Then, the main transport mechanism T₁, holding the cooled wafer W, moves to one of the antireflection film coating units BARC₁. The cooling unit CP₁ starts heat treatment (cooling) of the wafer W loaded therein (step S2). This heat treatment (cooling) will have been finished by the time the main transport mechanism T₁ accesses this cooling unit CP₁ next time. The following description assumes that wafers W having received predetermined treatments are present also in the other different heat-treating units 41 and coating units 31 when the main transport mechanism T₁ makes access thereto.

Accessing the antireflection film coating unit BARC₁, the main transport mechanism T₁ takes a wafer W having antireflection film formed thereon from the antireflection film coating unit BARC₁, and places the cooled wafer W on the spin holder 32 of the antireflection film coating unit BARC₁. Then, the main transport mechanism T₁, holding the wafer W having antireflection film formed thereon, moves to one of the heating and cooling units PHP₁. The antireflection film coating unit BARC₁ starts treatment of the PHP₁wafer W placed on the spin holder 32 (step S3).

Specifically, the spin holder 32 spins the wafer W in horizontal posture, the gripper 26 grips one of the nozzles 35, the nozzle moving mechanism 37 moves the gripped nozzle 35 to a position above the wafer W, and the treating solution for antireflection film is supplied from the nozzle 35 to the wafer W. The treating solution supplied spreads all over the wafer W, and is scattered away from the wafer W. The cup 33 collects the scattering treating solution. In this way, the treatment is carried out for forming antireflection film on the wafer W.

Accessing the heating and cooling unit PHP₁, the main transport mechanism T₁ takes a wafer W having received heat treatment out of the heating and cooling unit PHP₁, and loads the wafer W having antireflection film formed thereon into the heating and cooling unit PHP₁. Then, the main transport mechanism T₁, holding the wafer W taken out of the heating and cooling unit PHP₁, moves to one of the cooling units CP₁. The heating and cooling unit PHP₁ receives a wafer W successively on the two plates 43, to heat the wafer W on one of the plates 43 and then to cool the wafer W on the other plate 43 (step S4).

Having moved to the cooling unit CP₁, the main transport mechanism T₁ takes a wafer W out of the cooling unit CP₁, and loads the wafer W held by the transport mechanism T₁ into the cooling unit CP₁. The cooling unit CP₁ cools the wafer W loaded therein (step S5).

Then, the main transport mechanism T₁ moves to one of the resist film coating units RESIST₁. The main transport mechanism T₁ takes a wafer W having resist film formed thereon from the resist film coating unit RESIST₁, and loads the wafer W held by the main transport mechanism T₁ into the resist film coating unit RESIST₁. The resist film coating unit RESIST₁ supplies the resist film material while spinning the wafer W loaded therein, to form resist film on the wafer W (step S6).

The main transport mechanism T₁ further moves to one of the heating and cooling units PHP₁ and one of the cooling units CP₁. The main transport mechanism T₁ loads the wafer W having resist film formed thereon into the heating and cooling unit PHP₁, transfers a wafer W treated in the heating and cooling unit PHP₁ to the cooling unit CP₁, and receives a wafer W treated in the cooling unit CP₁. The heating and cooling unit PHP₁ and cooling unit CP₁ carry out predetermined treatments of newly loaded wafers W, respectively (steps S7 and S8).

The main transport mechanism T₁ moves to the receiver PASS₂, places the wafer W it is holding on the receiver PASS_{2A} (step S9), and receives a wafer W present on the receiver PASS_{2B} (step S21).

Subsequently, the main transport mechanism T₁ accesses the receiver PASS₁ again, and repeats the above operation. This operation is controlled by the second controller 94. As a result, all the wafers W transported from the cassette C to the receiver PASS₁ receive the same type of treatment in the treating units U provided on the story K1. Specifically, the same type of treatment refers to the treatment carried out in each of the cooling units CP₁, antireflection film coating units BARC₁, heating and cooling units PHP₁, cooling units CP₁, resist film coating units RESIST₁, heating and cooling units PHP₁ and cooling units CP₁ to which the wafers W are transported in order. All these treatments are pre-exposure treatments.

The main transport mechanism T₁ transports a wafer W having been transported to the receiver PASS₁ to a predetermined treating unit U1 (a cooling unit CP₁ in this embodiment), and takes a treated wafer W from this treating unit U1. Subsequently, the main transport mechanism T₁ transports the wafer W taken out to a different treating unit U1, and takes a treated wafer W from the different treating unit U1. In this way, the treatment is carried out in parallel for a plurality of wafers W by transferring a treated wafer W from each treating unit U1 to a new treating unit U1. Starting with a wafer W first placed on the receiver PASS₁, the wafers W are successively placed on the receiver PASS₂ to be fed to the story K2. Similarly, the wafers W are placed on the receiver PASS₁ in the order of placement on the receiver PASS₂, to be fed to the ID section 1.

### Main Transport Mechanisms T₂, T₄

Since operation of the main transport mechanism T₄ is substantially the same as operation of the main transport mechanism T₂, only the main transport mechanism T₂ will be described. The main transport mechanism T₂ moves to a position opposed to the receiver PASS₂. At this time, the main transport mechanism T₂ holds a wafer W received from a cooling unit CP₂ accessed immediately before. The main transport mechanism T₂ places this wafer W on the receiver PASS_{2B} (step S21), and holds the wafer W present on the receiver PASS_{2A} (step S9).

The main transport mechanism T₂ accesses the edge exposing unit EEW₂. The main transport mechanism T₂ receives a wafer W having received a predetermined treatment in the edge exposing unit EEW₂, and loads the cooled wafer W into the edge exposing unit EEW₂. While spinning the wafer W loaded therein, the edge exposing unit EEW₂ irradiates peripheral regions of the wafer W with light from the light emitter not shown, thereby exposing the peripheral regions of the wafer W (step S10).

The main transport mechanism T₂, holding the wafer W received from the edge exposing unit EEW₂, accesses the receiver PASS₅. The main transport mechanism T₂ places the wafer W on the receiver PASS_{5A} (step S11), and holds a wafer W present on the receiver PASS_{5B} (step S16).

The main transport mechanism T₂ moves to one of the cooling units CP₂, and replaces a wafer W in the cooling unit CP₂ with the wafer W held by the main transport mechanism T₂. The main transport mechanism T₂ holds the wafer W having received cooling treatment, and accesses one of the developing units DEV₂. The cooling unit CP₂ starts treatment of the newly loaded wafer W (step S17).

The main transport mechanism T₂ takes a developed wafer W from the developing unit DEV₂, and places the cooled wafer W on the spin holder 77 of the developing unit DEV₂. The developing unit DEV₂ develops the wafer W placed on the spin holder 77 (step S18). Specifically, while the spin holder 77 spins the wafer W in horizontal posture, the developer is supplied from one of the slit nozzles 81a to the wafer W, thereby developing the wafer W.

The main transport mechanism T₂ holds the developed wafer W, and accesses one of the heating units HP₂. The main transport mechanism T₂ takes a wafer W out of the heating unit HP₂, and loads the wafer W it is holding into the heating unit HP₂. Then, the main transport mechanism T₂ transports the wafer W taken out of the heating unit HP₂ to one of the cooling units CP₂, and takes out a wafer W already treated in this cooling unit CP₂. The heating unit HP₂ and cooling unit CP₂ carry out predetermined treatments for the newly loaded wafers W, respectively (steps S19 and S20).

Subsequently, the main transport mechanism T₂ accesses the receiver PASS₂ again, and repeats the above operation. This operation is controlled by the third controller 95. As a result, the wafers W are forwarded to the receiver PASS_{5B} in the order in which they are placed on the receiver PASS_{2A}. Similarly, the wafers W are forwarded to the receiver PASS_{2B} in the order in which they are placed on the receiver PASS_{5B}.

The control section 90 controls the IF transport mechanisms T_{IF} for causing all the plurality of wafers W that receive the same type of treatment in the same substrate treatment line L to be exposed on the same exposing stage S1 or exposing stage S2. Since the stories K constitute the substrate treatment lines in this embodiment, “the same substrate treatment line L” can also be put in another way as “the same stories K”. To carry out “the same type of treatment in the same substrate treatment line L” includes the case, as in this embodiment, where various types of treatment are all constantly carried out for the wafers W in the substrate treatment line Lu or Ld. However, such a case is not limitative. Each of various types of treatment included in the pre-exposure and post-exposure treatments may be carried out in the same substrate treatment line L. Specifically, the pre-exposure treatment may be carried out in the substrate treatment line Lu, and the post-exposure treatment in the substrate treatment line Ld. Part of the pre-exposure treatment (e.g. the treatment for forming resist film) may be carried out in the substrate treatment line Lu, and other pre-exposure treatment (e.g. edge exposing treatment for exposing peripheral regions of wafers W) in the substrate treatment line Ld.

The control section 90 controls in a way to avoid a situation where part of the plurality of wafers W that receive the same type of treatment in the same substrate treatment line L are exposed on the exposing stage S1, and the rest on the exposing stage S2. In this embodiment, wafers W are treated only in one of the substrate treatment lines Lu and Ld, the wafers W treated in the substrate treatment line Lu are all exposed on the exposing stage S1, and the wafers W treated in the substrate treatment line Ld on the exposing stage S2. With such control, it is possible to avoid concentration of the wafers W on one of the exposing stages S and lowering of the operating ratio of the other exposing stage S, thereby allowing the exposing machine EXP to expose the wafers W efficiently. The substrate treatment line L that carries out post-exposure treatment (e.g. post-exposure baking (PEB) treatment) of each wafer W is the same substrate treatment line L that carried out pre-exposure treatment (e.g. resist film formation) of that wafer W. This can make uniform the quality of the entire series of treatments including exposure and treatments before and after the exposure. Further, wafers W are not transported between the substrate treatment lines Lu and Ld, which facilitates transport control for each substrate treatment line L.

A specific example of control by the control section 90 will be described hereinafter. The control section 90 controls the IF transport mechanisms T_{IF} with reference to coordination information. The coordination information determines, for each wafer W, at least either which substrate treatment line L to treat the wafer W or which exposing stage S to expose the wafer W. As a preferred composition of the coordination information, treatment information which determines either of the substrate treatment lines Lu and Ld or either of the exposing stages S1 and S2 is related to substrate identification information which identifies each wafer W actually transferred between the IF section 5 and exposing machine EXP.

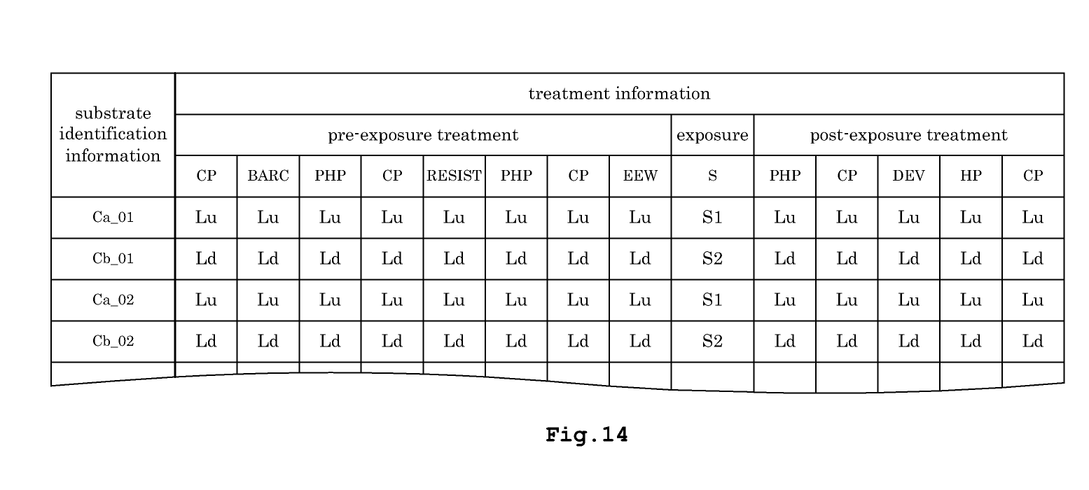

FIG. 14 is a schematic view showing an example of cooperation information. In the coordination information shown in FIG. 14, substrate identification information has treatment information determining which substrate treatment line L to carry out each type of treatment, and treatment information determining which exposing stage S to expose each wafer W. The control section 90 refers to the coordination information for causing each wafer W to be transported from the IF section 5 to the exposing machine EXP so that the wafer W may be exposed on the exposing stage S1 or S2 related thereto. Similarly, the control section 90 refers to the cooperation information for causing each wafer W to be transported from the exposing machine EXP to the IF section 5 so that the wafer W may be treated in the substrate treatment line L related thereto.

At this time, the control section 90 and the exposing machine controller communicate the coordination information or corresponding information and commands to each other to secure coordination between operations of the apparatus 10 and exposing machine EXP. Further, the control section 90 may be arranged to output information including commands and instructions for supervising or controlling the exposing machine EXP to the exposing machine controller. Alternatively, the control section 90 may be arranged to control the IF transport mechanisms T_{IF} to change a position for, or a method of, passing wafers W from the IF section 5 to the exposing machine EXP, thereby being capable of switching or selecting an exposing stage S for exposing each wafer W.

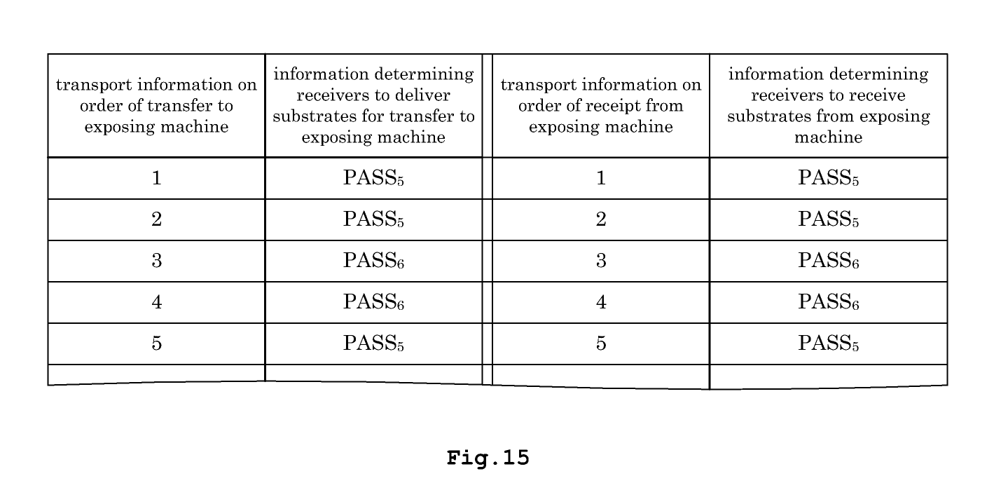

FIG. 15 is a schematic view showing another example of coordination information. This coordination information is used when an arrangement has been made beforehand between the apparatus 10 and exposing machine EXP. This arrangement is, for example, to determine which exposing stage S is to expose wafers W according to the order in which the wafers W are transferred to the exposing machine EXP.

In the coordination information shown in FIG. 15, specifically, transport information on an order of transferring wafers W from the IF section 5 to the exposing machine EXP includes a table relating information determining the receivers PASS to deliver wafers W for transfer to the exposing machine EXP to transport information on an order of transferring wafers W from the IF section 5 to the exposing machine EXP, and a table relating information determining the receivers PASS for receiving wafers W from the exposing machine EXP to transport information on an order in which the IF section 5 receives wafers W from the exposing machine EXP.

Since transport information “1”, “2” and so on can be related to the wafers W according to the order of transfer between the IF section 5 and exposing machine EXP, each transport information shown in FIG. 15 corresponds to the substrate identification information. In the two pieces of information determining the receivers PASS shown in FIG. 15, “PASS₅” indicates treatment in the substrate treatment line Lu, while “PASS₆” indicates treatment in the substrate treatment line Ld. That is, each of the two pieces of information determining the receivers PASS corresponds to the treatment information determining the substrate treatment line L. Therefore, the coordination information shown in FIG. 15 can be said to relate the treatment information determining which substrate treatment line L to treat the wafers W to the substrate identification information.

Based on the coordination information shown in FIG. 15, the control section 90 operates the IF transport mechanisms T_{IF} as follows. Transport a first wafer W received from the receiver PASS₅ to the exposing machine EXP. Then, transport a second wafer W received from the receiver PASS₅ to the exposing machine EXP. Next, transport third and fourth (two) wafers W received from the receiver PASS₆ to the exposing machine EXP. Next, transport a fifth wafer W received from the receiver PASS₅ to the exposing machine EXP. On the other hand, place a first and a second wafer W received from the exposing machine EXP on the receiver PASS₅. Place a third and a fourth wafer W received from the exposing machine EXP on the receiver PASS₆. Place a fifth wafer W received from the exposing machine EXP on the receiver PASS₅.

By operating the IF transport mechanisms T_{IF} in this way, the wafers W are transferred from the substrate treatment lines L selected successively to the exposing machine EXP, and the wafers W received from the exposing machine EXP are transferred to the substrate treatment lines L selected successively. As a result, the plurality of wafers W receiving the same type of treatment in the same substrate treatment line L are exposed on the same exposing stage S1 or S2. The coordination information shown in FIG. 15 is changeable as appropriate according to the contents of the arrangement. For example, if an arrangement determines one of the exposing stages S by timing such as a time of transferring each wafer W to the exposing machine EXP, the transport information will also be changed to specify the timing. In this case, the timing specified by the transport information, preferably, is selected and designed based on a transporting step for transporting wafers W and a treating step for treating wafers W. This is because timing can be presumed and set beforehand. However, transport information may be acquired from the time wafers W are actually transferred.

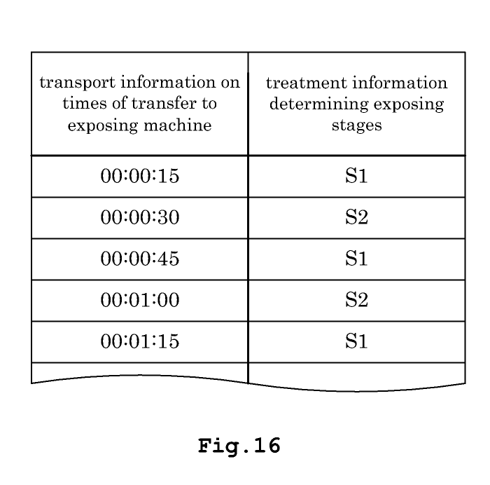

FIG. 16 is a schematic view showing a further example of coordination information. FIG. 16 illustrates coordination information having treatment information determining which exposing stage S to expose wafers W related to transport information on times of transfer to the exposing machine. The transport information on times of transfer to the exposing machine shown in FIG. 16 corresponds to the substrate identification information. The control section 90 receives this coordination information from the exposing machine controller, determines which exposing stage S to expose each wafer W, and switches the substrate treatment lines L for treating each wafer W based on this coordination information. Alternatively, the control section 90 transmits this coordination information to the exposing machine controller to control the exposing stage S which exposes each wafer W, and switches the substrate treatment lines L for treating each wafer W based on this coordination information.

Although it has been described that the control section 90 carries out the control of the IF transport mechanisms T_{IF} specifically any one of the main controller 91, sixth controller 98 and seventh controller 99 may carry out the control, or these controllers may share the control appropriately.

An example of operation of each of the first transport mechanism T_{IFA} and second transport mechanism T_{IFB} will be described hereinafter. It should be noted, however, that operations of the first transport mechanism T_{IFA} and second transport mechanism T_{IFB} are changed as appropriate according to the control carried out by the control section 90 with reference to the coordination information described above.

### IF Transport Mechanisms T_{IF}—First Transport Mechanism T_{IFA}

The first transport mechanism T_{IFA} accesses the receiver PASS₅, and receives the wafer W present on the receiver PASS_{5A} (step S11a). The first transport mechanism T_{IFA}, holding the wafer W received, moves to the receiver PASS-CP, and loads the wafer W on the receiver PASS-CP (step S12).

Next, the first transport mechanism T_{IFA} receives a wafer W from the receiver PASS₇ (step S14), and moves to a position opposed to one of the heating and cooling units PHP₂. The first transport mechanism T_{IFA} takes a wafer W having received post-exposure baking treatment (PEB) treatment from the heating and cooling unit PHP₂, and loads the wafer W received from the receiver PASS₇ into the heating and cooling unit PHP₂. The heating and cooling unit PHP₂ carries out heat treatment for the newly loaded wafer W (step S15a).

The first transport mechanism T_{IFA} transports the wafer W taken out of the heating and cooling unit PHP₂ to the receiver PASS_{5B}. Subsequently, the first transport mechanism T_{IFA} transports a wafer W from the receiver PASS_{6A} to the receiver PASS-CP (Step S11b, S12). Next, the first transport mechanism T_{IFA} transports a wafer W from the receiver PASS₇ to one of the heating and cooling units PHP₄. At this time, the first transport mechanism T_{IFA} takes out a wafer W having received the post-exposure baking treatment (PEB) treatment in the heating and cooling unit PHP₄, and places the wafer W on the receiver PASS_{6B} (steps S14, S15b, S16b).

Subsequently, the first transport mechanism T_{IFA} accesses the receiver PASS₅ again and repeats the above operation.

### IF Transport Mechanisms T_{IF}—Second Transport Mechanism T_{IFB}

The second transport mechanism T_{IFB} takes a wafer W out of the receiver PASS-CP, and transports it to the exposing machine EXP. Then, the second transport mechanism T_{IFB} receives an exposed wafer W from the exposing machine EXP, and transports it to the receiver PASS₇ (step S13).

Subsequently, the second transport mechanism T_{IFB} accesses the receiver PASS-CP again and repeats the above operation.

In the substrate treating apparatus according to this embodiment, as described above, the control section 90 controls transport of wafers W in the IF section 5 to cause all the plurality of wafers W that receive the same type of treatment in the same substrate treatment line L to be exposed on the same exposing stage S. Compared with the case of using the plurality of exposing stages S together, this control can inhibit variations in the quality of entire treatment including the treatment in the substrate treatment lines L and exposure in the exposing machine EXP occurring among the plurality of wafers W receiving the same type of treatment in the same substrate treatment line L.

The control section 90, which refers to the coordination information for control, can carry out the control effectively.

The coordination information has treatment information related to substrate identification information which identifies each wafer W actually transferred between the IF section 5 and exposing machine EXP that determines the substrate treatment lines Lu and Ld and/or the exposing stages S1 and S2,. It is therefore possible to cause each wafer W transferred to be treated in a desired one of the substrate treatment lines L and exposed on a desired one of the exposing stages S.

The treatment in each substrate treatment line L includes resist film forming treatment and post-exposure baking (PEB) treatment. This ensures uniform quality of the entire treatment including the resist film forming treatment, exposure and post-exposure baking (PEB) treatment.

Each substrate treatment line L, with the plurality of main transport mechanisms T, can transport wafers W efficiently.

Each substrate treatment line L has a plurality of resist film coating units RESIST arranged at substantially the same height. Thus, the quality of treatment can be made uniform among the resist film coating units RESIST.

Each substrate treatment line L has a plurality of antireflection film coating units BARC arranged at substantially the same height. Thus, the quality of treatment can be made uniform among the antireflection film coating units BARC.

The resist film coating units RESIST and antireflection film coating units BARC provided for each substrate treatment line L are stacked vertically. This arrangement realizes a reduced installation area.

The atmosphere around each antireflection film coating unit BARC is not blocked off (i.e. is in communication), nor is the atmosphere around each resist film coating unit RESIST blocked off. Thus, environment can be further made uniform among the resist film coating units RESIST and among the antireflection film coating units BARC.

The treating section 3, which has the substrate treatment lines L, is formed of a plurality of (two) treating blocks Ba and Bb arranged horizontally (substantially in the same direction as the transport direction). Thus, a treating section 3 suited to the contents and object of treatment carried out for wafers W can be formed easily by combining two or more types of treating blocks Ba and Bb as appropriate.

Atmosphere is blocked off between the stories K of each treating block Ba or Bb. This allows the atmosphere of each story K to be easily maintained clean. It is also easy to keep the environment on each story K constant.

This invention is not limited to the foregoing embodiment. Some other exemplary embodiments are described in the following paragraphs.

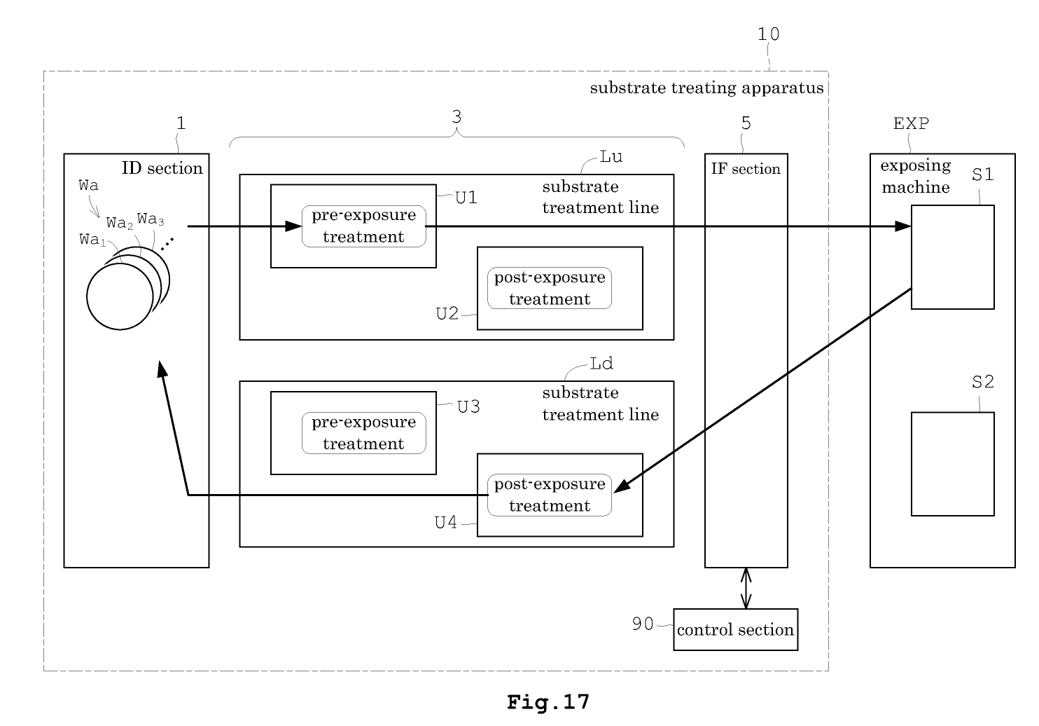

It has been described in the foregoing embodiment that the substrate treatment line L which carries out post-exposure treatment (e.g. post-exposure baking (PEB) treatment) for each wafer W preferably is the same substrate treatment line L having carried out pre-exposure treatment (e.g. resist film forming treatment) for that wafer W. However, different treatment lines may be used for each wafer W. As shown in FIG. 17, for example, a group of wafers Wa may receive pre-exposure treatment in the substrate treatment line Lu, and post-exposure treatment in the substrate treatment line Ld. In this case also, all of the wafers Wa have the same history of treatment to realize uniformity in the quality of treatment among the wafers Wa.

It has been described in the foregoing embodiment that the separate exposing machine EXP is disposed adjacent the apparatus 10. Instead, the apparatus 10 may not be close to the exposing machine EXP. In such a case also, the plurality of resist film coating units RESIST provided for each substrate treatment line L are arranged at substantially the same height, and thus the quality of treatment can be uniformed among these coating units. Similarly, the plurality of antireflection film coating units BARC provided for each substrate treatment line L are arranged at substantially the same height, and thus the quality of treatment can be uniformed among these coating units.

The foregoing embodiment provides two substrate treatment lines L, but the invention not limited to this. The construction may be modified to include three or more substrate treatment lines L vertically arranged in multiple stages.

In the foregoing embodiment, the treating section 3 having the substrate treatment lines L is formed of two treating blocks Ba and Bb, but the invention not limited to this. The construction may be modified to include three or more treating blocks arranged side by side.

In the foregoing embodiment, the substrate treatment lines L carry out the treatment for forming resist film and antireflection film on the wafers W, as well as the post-exposure baking (PEB) treatment and developing treatment. The substrate treatment lines L may be modified to perform other treatment such as cleaning of the wafers W. Accordingly, the type, number and the like of treating units are selected or designed as appropriate. Further, the substrate treating apparatus may be constructed to exclude the IF section 5.

The exposing machine EXP described above has two exposing stages S, but this is not limitative. The apparatus 10 is usable also with an exposing machine EXP having three or more exposing stages S.

In the foregoing embodiment, the wafers W may be transported to the substrate treatment line L and exposing machine EXP for additional times, i.e. twice or more, to form circuit patterns in two or more separate steps on the same oxide film acting as underlying film. In this process, the substrate treatment line L to which the wafers W are transported for the second time or later time may be the same substrate treatment line L to which the wafers W are transported for the first time. Then, the quality of circuit pattern linewidth may be made uniform between the circuit pattern formed in the first step and that formed in the second step.

The foregoing embodiment provides no partition or the like between the antireflection film coating units BARC and resist film coating units RESIST arranged on each story K1 or K2, but allows the atmosphere to be shared among these coating units. Instead, the atmosphere may be blocked off as appropriate.

This invention may be embodied in other specific forms without departing from the spirit or essential attributes thereof and, accordingly, reference should be made to the appended claims, rather than to the foregoing specification, as indicating the scope of the invention.

What is claimed is:

1. A substrate treating apparatus comprising:
a plurality of substrate treatment lines arranged one over another, each for treating substrates while transporting the substrates substantially horizontally;
an interface section for transporting the substrates between the substrate treatment lines and an exposing machine having a plurality of exposing stages, the exposing machine being provided separately from the apparatus; and
a controller for controlling transport of the substrates in the interface section to cause all the substrates similarly treated in each of the substrate treatment lines to be exposed on one of the exposing stages.

2. The apparatus according to claim 1, wherein the controller is arranged to control the transport of the substrates in the interface section by referring to coordination information which determines, for each substrate, at least one of which substrate treatment line to treat the substrate and which exposing stage to expose the substrate.

3. The apparatus according to claim 2, wherein the coordination information includes treatment information which determines at least one of which substrate treatment line to treat the substrate and which exposing stage to expose the substrate, the treatment information including substrate identification information which identifies each substrate actually transferred between the interface section and the exposing machine.

4. The apparatus according to claim 1, wherein:
treatment carried out in the substrate treatment lines includes resist film forming treatment for forming resist film on the substrates, and post-exposure baking (PEB) treatment for heating the substrates after exposure; and
the controller is arranged to control the transport of the substrates in the interface section to cause all the substrates receiving the resist film forming treatment in each of the substrate treatment lines to be exposed on one of the exposing stages and to receive the post-exposure baking (PEB) treatment in one of the substrate treatment lines.

5. The apparatus according to claim 4, wherein the substrate treatment line which gives the post-exposure baking (PEB) treatment to the substrates is the substrate treatment line which has given the resist film forming treatment to the substrates.

6. The apparatus according to claim 1, wherein each of the substrate treatment lines includes:
a plurality of main transport mechanisms arranged substantially horizontally and
a plurality of treating units provided for each of the main transport mechanisms for treating the substrates; and
each main transport mechanism is arranged to transfer the substrates to another main transport mechanism substantially horizontally adjacent thereto, while transporting the substrates to the treating units associated with the each main transport mechanism, thereby carrying out a series of treatments for the substrates.

7. The apparatus according to claim 6, wherein:
the treating units provided in each substrate treatment line include resist film coating units for applying a resist film material to the substrates; and
all the substrates with the resist film formed in a same one of each substrate treatment line are exposed on a same one of the exposing stages.

8. The apparatus according to claim 7, wherein the plurality of resist film coating units provided in each substrate treatment line are arranged in substantially equal height positions.

9. The apparatus according to claim 8, wherein:
the treating units provided in each substrate treatment line further include PEB units for giving post-exposure baking (PEB) treatment to the substrates after exposure; and
the substrate treatment line which gives post-exposure baking (PEB) treatment to the substrates is the substrate treatment line which has applied the resist film material to the substrates.

10. The apparatus according to claim 1, wherein the substrates are transported to each of the substrate treatment lines and to the exposing machine at least twice, to form circuit patterns in at least two separate steps on a film acting as underlying film, the substrate treatment line to which the substrates are transported for a second time or later time being the same substrate treatment line to which the substrates are transported for a first time.

11. A substrate treating apparatus comprising:
a treating section including a plurality of treating blocks arranged horizontally, each treating block having treating units arranged on each of vertical stories for treating substrates, and a main transport mechanism disposed on each story for transporting the substrates to and from the treating units on each story, a series of treatments being carried out by transferring the substrates between the main transport mechanisms on the same story of the treating blocks adjacent each other;
an interface section disposed adjacent the treating section for transporting the substrates between the treating section and an exposing machine having a plurality of exposing stages, the exposing machine being provided separately from the apparatus; and
a controller for controlling transport of the substrates in the interface section to cause all the substrates similarly treated on each of the stories to be exposed on a same one of the exposing stages.

12. The apparatus according to claim 11, wherein the controller is arranged to control the transport of the substrates in the interface section by referring to coordination information which determines, for each substrate, at least one of which story to treat the substrate and which exposing stage to expose the substrate.

13. The apparatus according to claim 12, wherein the coordination information includes treatment information which determines at least one of which story to treat the substrate and which exposing stage to expose the substrate, the treatment information including substrate identification information which identifies each substrate actually transferred between the interface section and the exposing machine.

14. The apparatus according to claim 11, wherein each story has an atmosphere blocked off from that of the other.

15. The apparatus according to claim 11, wherein:
one of the treating blocks is a coating block having resist film coating units arranged as the treating units on each story for applying a resist film material to the substrates; and
all the substrates having the resist film formed thereon on each story are exposed on a same one of the exposing stages.

16. The apparatus according to claim 15, wherein the plurality of resist film coating units provided on each story are arranged in substantially equal height positions.

17. The apparatus according to claim 15, wherein one of the treating blocks different from the coating block is a PEB block having PEB units arranged as the treating units on each story for carrying out post-exposure baking (PEB) treatment for heating the substrates after exposure; and
the story having the PEB block which gives post-exposure baking (PEB) treatment to the substrates is the story having the coating block which has applied the resist film material to the substrates.

18. The apparatus according to claim 11, wherein the substrates are transported to the treating section and to the exposing machine at least twice, to form circuit patterns in at least two separate steps on a film acting as underlying film, the story of the treating section to which the substrates are transported for a second time or later time being the same story of the treating section to which the substrates are transported for a first time.

19. A substrate treating apparatus comprising:
a plurality of substrate treatment lines arranged one over another, each for treating substrates while transporting the substrates substantially horizontally;
each substrate treatment line including film forming units for forming film on the substrates;
wherein all the film forming units of each substrate treatment line which form the same type of film are arranged in substantially equal height positions.

20. The apparatus according to claim 19, wherein:
the film forming units provided in each substrate treatment line include a plurality of resist film coating units for forming resist film; and
all the resist film coating units of each substrate treatment line are arranged in substantially equal height positions.

21. The apparatus according to claim 20, wherein:
the film forming units provided in each substrate treatment line include a plurality of antireflection film coating units for forming antireflection film on the substrates; and
all the antireflection film coating units of each substrate treatment line are arranged in substantially equal height positions.

22. The apparatus according to claim 21, wherein the resist film coating units and the antireflection film coating units of each substrate treatment line are stacked vertically.

23. The apparatus according to claim 22, further comprising:
a main transport mechanism movable along a substantially horizontal transport path for transporting the substrates;
wherein the resist film coating units and the antireflection film coating units are arranged along the transport path of the main transport mechanism.

24. A substrate treating apparatus comprising:
an indexer section including an indexer transport mechanism for transporting substrates to and from a cassette configured to store a plurality of substrates;
a coating block disposed adjacent the indexer section, and including coating units for applying a treating solution to the substrates and heat-treating units arranged on each of upper and lower stories, and a main transport mechanism disposed on each story for transporting the substrates to and from the coating units and the heat-treating units on the each story;
a developing block disposed adjacent the coating block, and including developing units for supplying a developer to the substrates and heat-treating units arranged on each of upper and lower stories, and a main transport mechanism disposed on each story for transporting the substrates to and from the developing units and the heat-treating units on the each story; and
an interface section disposed adjacent the developing block, and including an interface transport mechanism for transporting the substrates to and from an exposing machine provided separately from the apparatus;
wherein all the coating units on each story which apply the same type of treating solution to the substrates are arranged in substantially equal height positions;
the indexer transport mechanism transfers the substrates to and from the main transport mechanism on each story of the coating block;
the main transport mechanism on each story of the coating block transfers the substrates to and from the main transport mechanism on the same story of the developing block; and
the interface transport mechanism transfers the substrates to and from the main transport mechanism on each story of the developing block.

25. The apparatus according to claim 24, wherein:
the coating units provided on each story of the coating block include a plurality of resist film coating units for applying a resist film material to the substrates, and a plurality of antireflection film coating units for applying an anti-reflection film forming solution to the substrates; and
on each story, the resist film coating units are arranged in substantially equal height positions, and the antireflection film coating units are arranged in substantially equal height positions.

26. The apparatus according to claim 24, wherein the heat-treating units of the developing block include PEB units for carrying out post-exposure baking (PEB) treatment for the substrates after exposure.
